(19) United States
(12) Patent Application Publication
(10) Pub. No.: US 2016/0224935 A1
(43) Pub. Date: Aug. 4, 2016

(54) Shipper and Carrier Interaction Optimization Platform

(71) Applicant: Rick Burnett, San Diego, CA (US)

(72) Inventor: Rick Burnett, San Diego, CA (US)

(21) Appl. No.: 15/092,515

(22) Filed: Apr. 6, 2016

Related U.S. Application Data
(63) Continuation-in-part of application No. 14/794,619, filed on Jul. 8, 2015.
(60) Provisional application No. 62/022,165, filed on Jul. 8, 2014.

(51) Int. Cl. G06Q 10/08

(52) U.S. Cl. CPC G06Q 10/0834

(57) ABSTRACT

A system for optimizing selection of a carrier for a shipment at a shipment location includes an interaction optimization platform. The interaction optimization platform has a carrier interface and a progress interface. The carrier interface is configured to display, on a carrier display device, carrier data fields for receiving carrier information regarding equipment capabilities and/or availability corresponding to a carrier. The progress interface is configured to display, on the shipper display device, shipment information comprising the shipment location. A server is configured to, by execution of the interaction optimization platform, perform operations including receiving electronic data comprising the shipment information. Also, the server compares the shipment location to locations stored in a server memory. Data is transmitted to the carrier interface that includes an indication that the shipment location is within a predefined distance from at least one of the locations and also transmitting location features including a location name.

### CROSS-REFERENCE TO RELATED APPLICATION

This application is a continuation-in-part of, and claims priority under 35 U.S.C. §120 to, U.S. patent application Ser. No. 14/794,619 filed Jul. 8, 2015, which claims priority under 35 U.S.C. §119(e) to U.S. Provisional Patent Application Ser. No. 62/022,165, titled “Shipper and Carrier Interaction Optimization Platform,” filed Jul. 8, 2014, the disclosures of which are hereby incorporated by reference in their entirety herein.

### TECHNICAL FIELD

The subject matter described herein relates generally to the shipping of physical goods, particularly via land based vehicles such as truck, rail, and the like.

### BACKGROUND

Matching shipments of goods to carriers can be a tedious undertaking. Currently, much of the matchmaking between shippers and carriers is carried out by third parties, such as brokers. The involvement of brokers, as well as the use of older means of communication and tracking can lead to increased costs or loss of potential income. The increased costs can include increased overhead payments to third parties, and loss of potential income can stem from increased time to find a carrier for each shipment, carriers moving equipment that is not fully utilized, and unexpected delays or exceptions that are not adequately communicated to the shipper.

### SUMMARY

In one aspect, a system for optimizing selection of a carrier for a shipment at a shipment location includes an interaction optimization platform. The interaction optimization platform has a carrier interface and a progress interface. The carrier interface is configured to display, on a carrier display device, carrier data fields for receiving carrier information regarding equipment capabilities and/or availability corresponding to a carrier. The progress interface is configured to display, on the shipper display device, shipment information comprising the shipment location. A server is configured to, by execution of the interaction optimization platform, perform operations including receiving electronic data comprising the shipment information. Also, the server compares the shipment location to locations stored in a server memory. Data is transmitted to the carrier interface that includes an indication that the shipment location is within a predefined distance from at least one of the locations and also transmitting location features including a location name.

In some variations one or more of the following features can optionally be included in any feasible combination. The carrier information can also include safety capabilities. The server can be configured to receive, from a second server, electronic data comprising safety requirements for transporting the shipment. The server can also determine, based on the safety requirements and the safety capabilities, which of the carriers meets the safety requirements. The carrier interface can display a graphical indication of the carriers that meet the safety requirements.

The server can monitor a status of a carrier. The status can indicate compliance with a previously confirmed set of rules or with an electronic document previously received by the carrier and the shipper. A notification can be transmitted by the server to the carrier and the shipper based on the monitoring determining that the carrier is not in compliance with the set of rules or with the electronic document.

The server can transmit to potential suitable carriers, shipment information when the potential suitable carriers meet shipment requirements defined by the shipper with a shipper interface and received by the server.

The server can transmit instructions to the carrier interface disabling the carrier interface from receiving at least some user input while a mobile device executing the carrier interface is moving, the determination of the carrier interface as moving based on at least GPS data received at the server.

The server can transmit, to the carrier interface, instructions to display a graphical output offer data comprising a location of interest when the location of interest is within a predefined distance from the shipment location. The server can also receive, at intervals defined by a shipper interface, the shipment information.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating an exemplary system that includes a shipper and carrier interaction optimization platform for interaction between one or more shipper and one or more carrier;

FIG. 2 shows a flow chart showing an exemplary method for creating a shipper profile on the interaction optimization platform described herein;

FIGS. 3A-3C show exemplary views of the shipper interface of the interaction optimization platform during profile set-up;

FIG. 4 shows a flow chart showing an exemplary method for creating a carrier profile on the interaction optimization platform described herein;

FIGS. 5A-5E show exemplary views of the carrier interface of the interaction optimization platform during profile set-up;

FIGS. 6A-6J show exemplary views of the carrier interface of the interaction optimization platform on a hand-held mobile device;

FIGS. 7A-7C show exemplary flow charts of shipper and carrier interaction via the interaction optimization platform;

FIGS. 8A-8H show representative views of the interaction optimization platform, as in some implementations described herein; and

FIG. 9 shows a flow chart showing an exemplary method of providing data regarding locations of interest based on their proximity to the shipment location.

When practical, similar reference numbers denote similar structures, features, or elements.

### DETAILED DESCRIPTION

A platform that allows for interaction between shippers and carriers through the internet is provided. The platform allows for shippers to post their shipping needs, for carriers to post their equipment and workforce availability, and for both shippers and carriers to bid on the opportunity to use equipment or provide shipping services, respectively. In addition to facilitating interaction which leads to hiring or service providing contracts, the platform can provide tools to track each shipment, to estimate the arrival time of each shipment, to account for delivery or shipment exceptions, to estimate the cost for any shipment, to estimate the break-even point for any shipment, to generate proof of delivery, to suggest shipments or equipment availability to optimize efficiency or best meet needs, or any combination thereof.

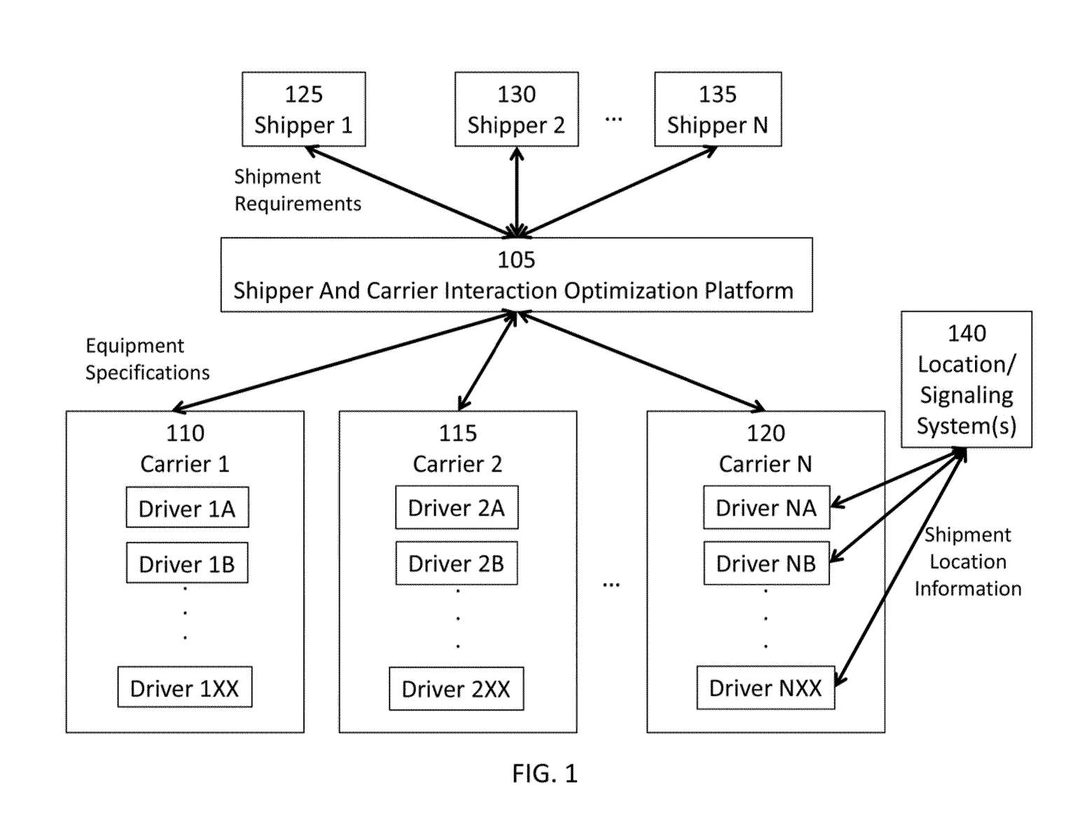

FIG. 1 is a diagram illustrating an exemplary system that includes a shipper and carrier interaction optimization platform 105 for interaction between one or more carriers 110, 115, 120 and one or more shippers 125, 130, 135. Each carrier 110, 115, 120 can employ multiple drivers. The one or more shippers 125, 130, 135 can provide input to the shipper and carrier interaction optimization platform 105. This input from the one or more shippers can include shipment requirements and/or bids to ship using available equipment. The one or more carriers 110, 115, 120 can provide input to the shipper and carrier interaction optimization platform 105. This input from the one or more carriers can include equipment specification and/or bids on the cost to ship one or more particular shipments. These inputs, as well as information from the shipper and carrier interaction optimization platform 105 to each of the one or more carriers and one or more shippers will be described in further detail, herein below. The system can also include location and/or signaling systems 140 that work with a mobile computing device used by drivers. The location and/or signaling systems 140 can include GPS location systems, wireless internet systems, cellular phone signaling systems, or a combination of those systems, or another wireless communication system that can receive data or generate data regarding the location of the mobile computing device. Knowing the location of a driver's mobile computing device while he or she is transporting a shipment can allow the interaction optimization platform to determine the location of the shipment and display progress information to the shipper and/or carrier.

The shipper and carrier interaction optimization platform can include one or more of a web-based user interface, such as a web site; a dedicated application for use on a hand-held device, such as an app; and a dedicated computing device with a graphical user interface. The hand-held device can be a tablet, smartphone, cell phone, wearable electronic interface such as an electronic watch, or the like. The shipper and carrier interaction optimization platform can accept input from one or more shipper and/or one or more carrier. The shippers and carriers associated with the shipper and carrier interaction optimization platform can be referred to as the associated shipping community.

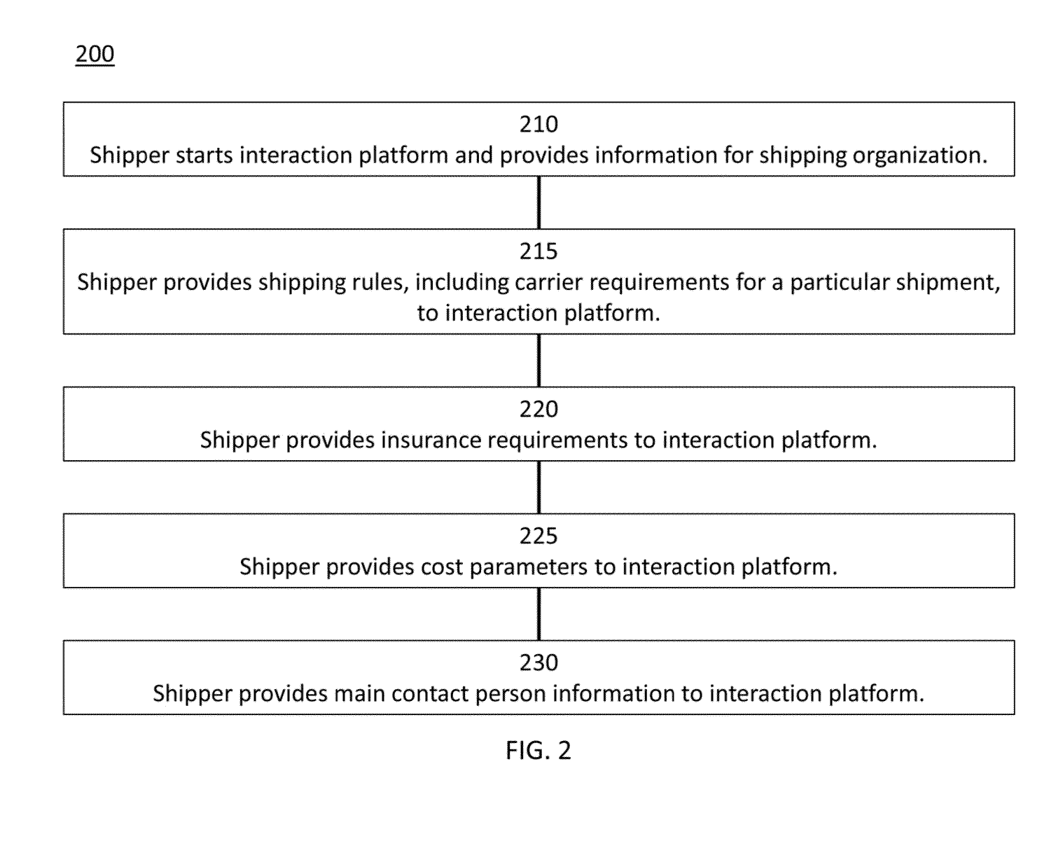

FIG. 2 shows an exemplary method 200 for a shipper to join the shipping community associated with the interaction optimization platform (105 in FIG. 1). The shipper can have an application for interfacing with the interaction optimization platform on a mobile computing device, or the shipper can use a web site to view a shipper interface generated by the interaction optimization platform. Once the shipper has initiated contact with the interaction optimization platform, he or she can provide information about the shipping organization to the platform, as in 210. The type of information is described more fully, below, but can include the company name, address, type of goods normally shipped, and the like. The shipping company can have rules, including carrier requirements, which are specified in 215 to better enable the interaction optimization platform to match a carrier to a shipment. The shipper can also provide insurance requirements 220, and cost limitations 225 to the interaction optimization platform to help narrow down the field of potential suitable carriers or to help the shipper create a suitable bid on the use of equipment for a shipment. The shipper can complete the profile for his or her shipping company by including the contact particulars for a person responsible for the proposed shipment, as in 230. This responsible person can be the default responsible person, shown in the system to always be responsible for shipments, or the responsible person can vary from shipment to shipment.

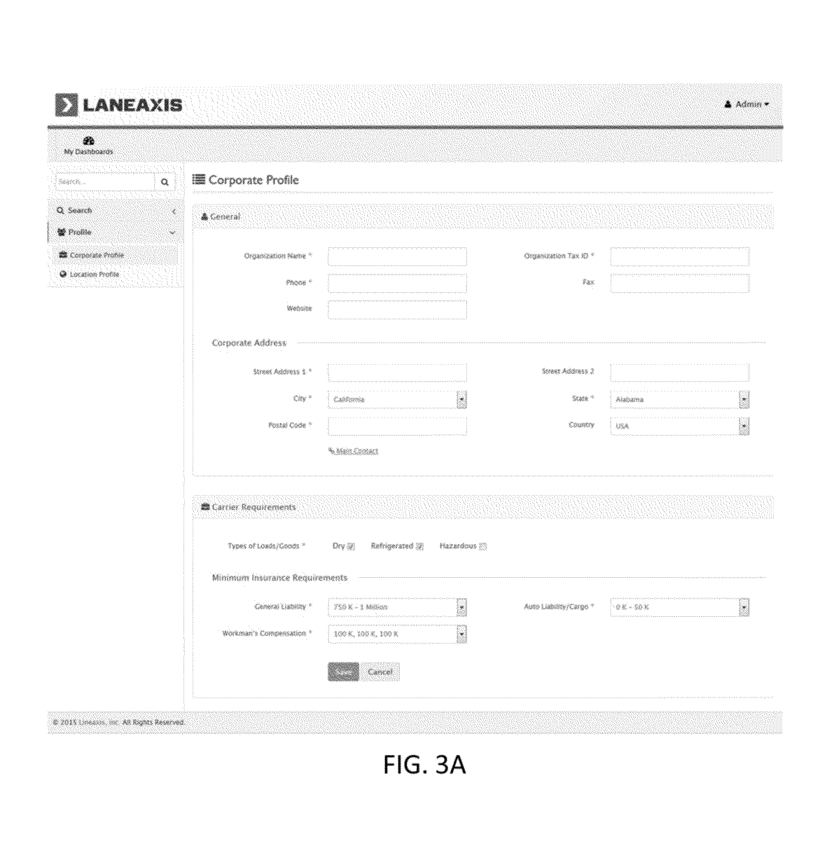

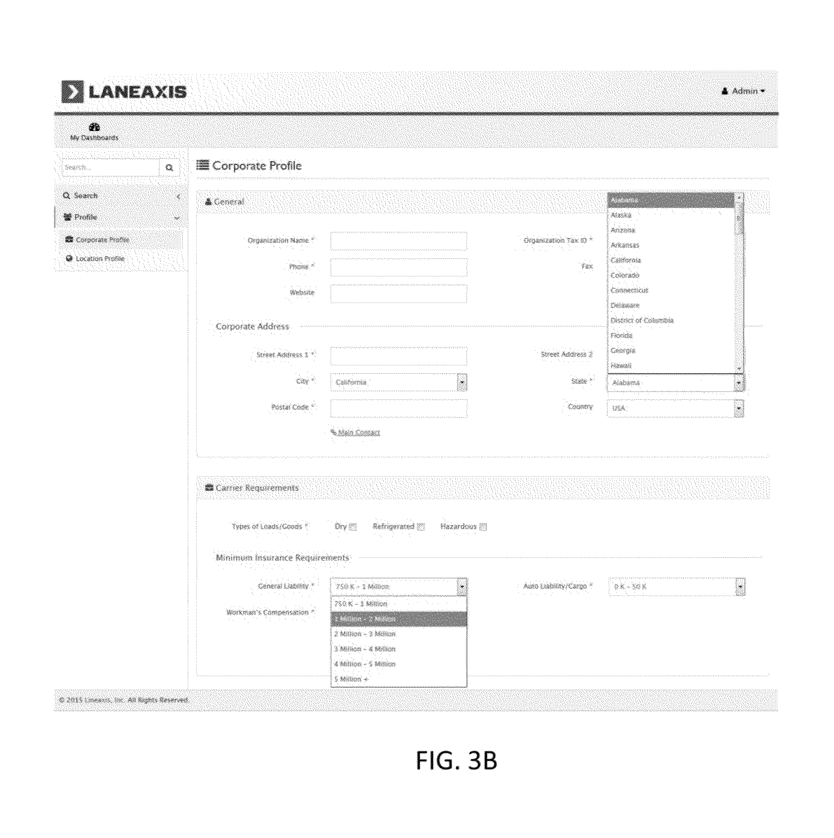

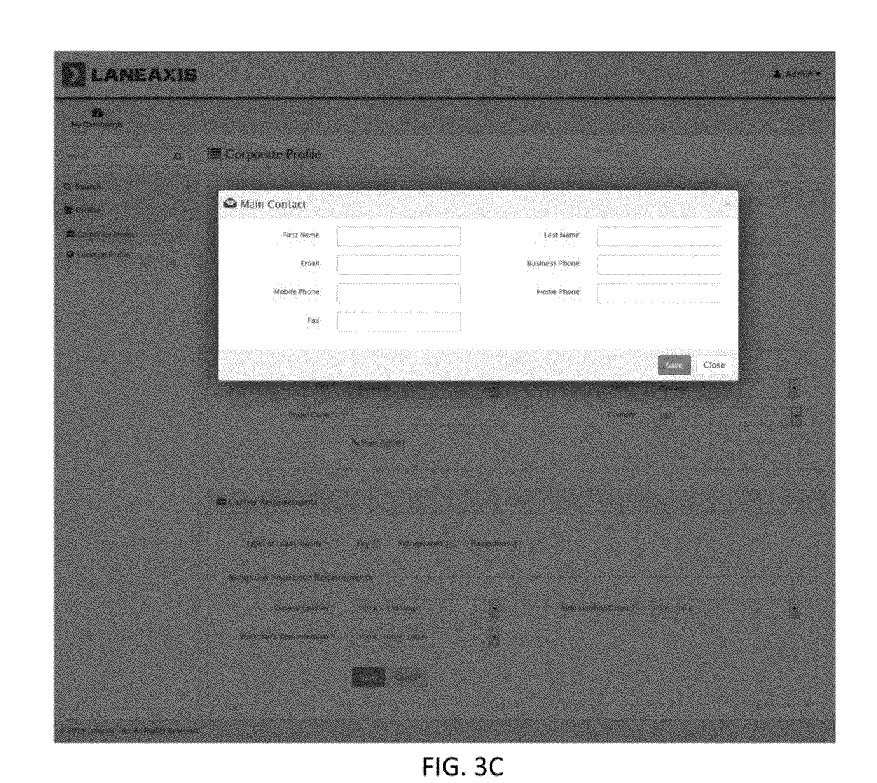

FIGS. 3A-3C show exemplary views of the shipper interface when setting up a shipper profile. In order for a shipper to create a shipper profile and join the associated shipping community, the shipper provides log-in information, shipper information (e.g., business name and address), criteria for carriers (e.g., CSA score requirement, insurance requirement, performance requirement, and the like), and a main contact, as seen in FIGS. 3A-3C. In some implementations, the interaction optimization platform can either receive push updates or can query a remote server to download or access safety requirements for transporting the shipment. For example, current safety requirements from official agencies, or the shippers own internal requirements, can be received automatically in response to an update in the safety requirements. The current safety requirements can then be applied to the available carriers in order to show which carriers meet the current safety requirements. The carriers that meet the current safety requires can be displayed by the shipper interface and include a graphical indication identifying the carriers as such. The shipper can also provide a list of preferred carriers to the shipper and carrier interaction optimization platform. Once the shipper has a profile and is a member of the associated shipping community, the shipper can upload one or more shipments/loads, either by providing an electronic file with the shipment data or by using the interface to provide the information. A shipper that is a member of the associated shipping community can also bid to use equipment posted as available.

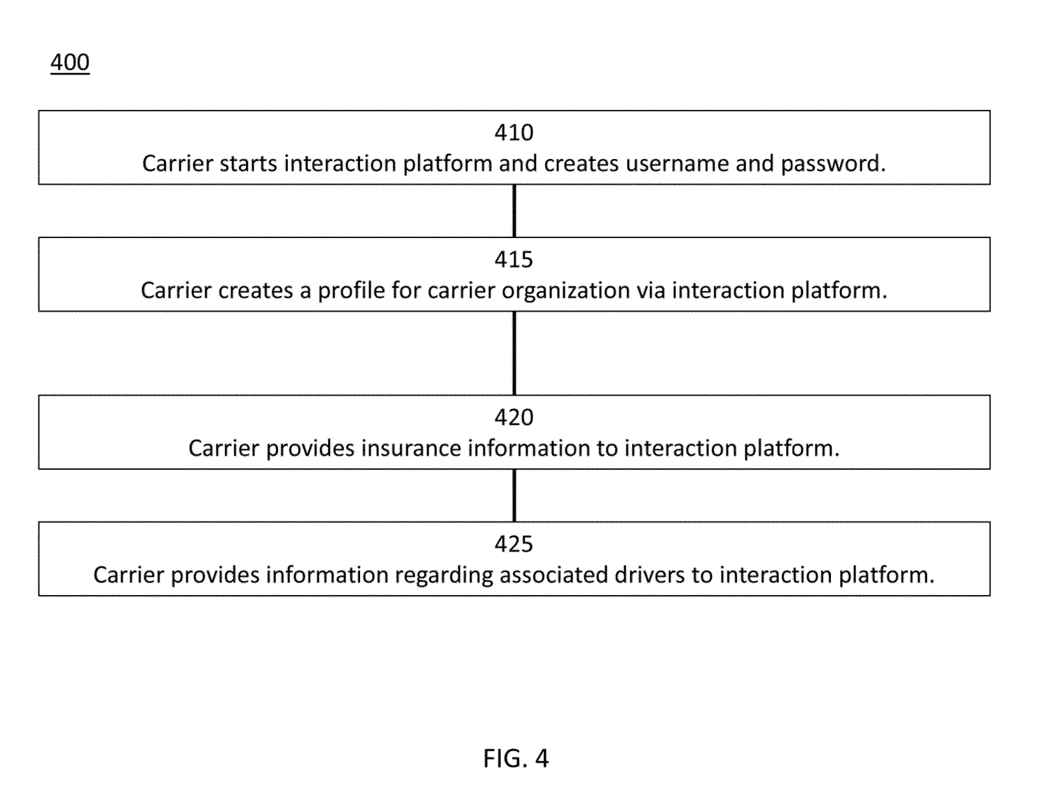

FIG. 4 shows an exemplary method 400 for creating a carrier profile for the interaction optimizing platform. The carrier can interact with the interaction optimizing platform via a carrier interface that is presented via a web site or a dedicated application (i.e. app) on a mobile computing device. The carrier can create a username and password upon starting up the carrier interface for the interaction optimizing platform, as in 410. The company information can be provided to the platform to create the barest of carrier profiles, as in 415. The insurance information provided, as in 420, as well as information about drivers associated with the carrier, as in 425, help to round out the creation of a carrier profile. In some implementations, the insurance information can be verified by the interaction optimization platform. For example, upon entering the insurance information, the information can be analyzed by parsing the data entry fields to identify the insurance provider, identifying numbers, and the like. Data including one or more identifying features of the insurance information can be transmitted to an insurance company server. The interaction optimization platform can also receive, from the insurance company server, electronic verification of the carrier having valid insurance. The electronic verification can be provided graphically on the shipper platform or stored on another server. In other implementations, if valid insurance is unable to be verified, an indication of this can be provided on the shipper interface or stored by the interaction optimization platform.

The driver information can be provided by manually entering information into fields presented in the carrier interface. Alternatively, or additionally, driver information can be provided in a spread sheet, text delimited file, or as any other array of data in a file that is uploaded to the interaction optimization platform.

In some implementations, when one or more drivers have been specified through the interaction optimization platform, a text message or other electronic communication can be sent to the drivers inviting them to download the carrier interface as a mobile application that will enable them to join the interaction optimization platform. The electronic communication can require the driver to confirm their desire to join the interaction optimization platform. Once confirmed by the driver, the interaction optimization platform can initiate download of the carrier interface onto the driver's mobile computing device.

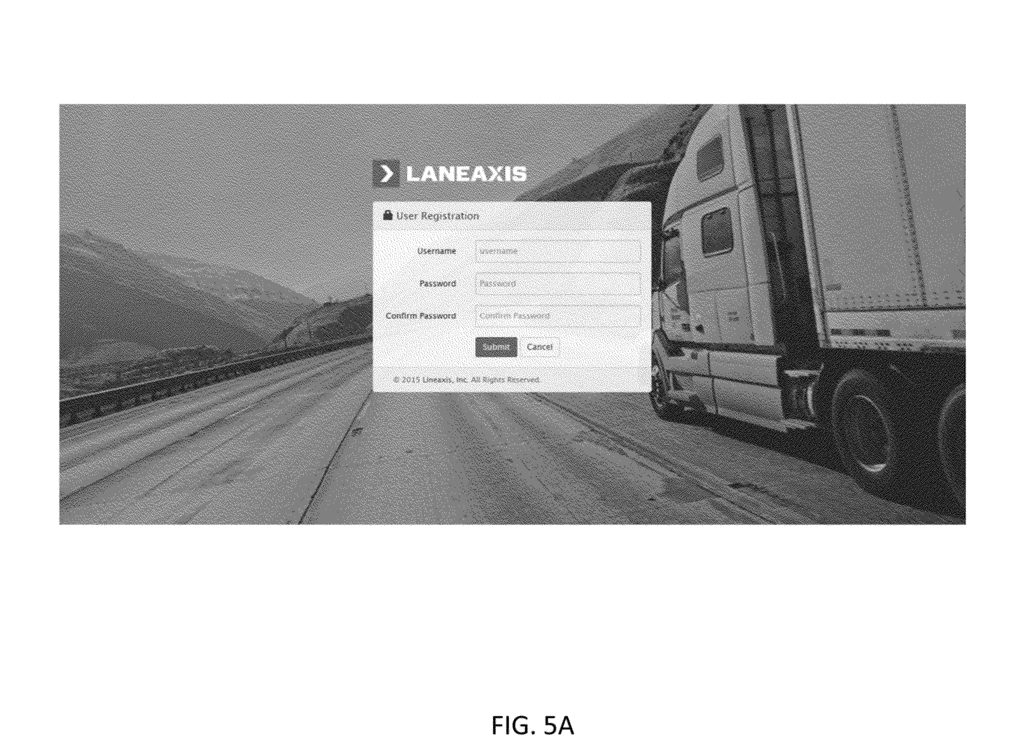

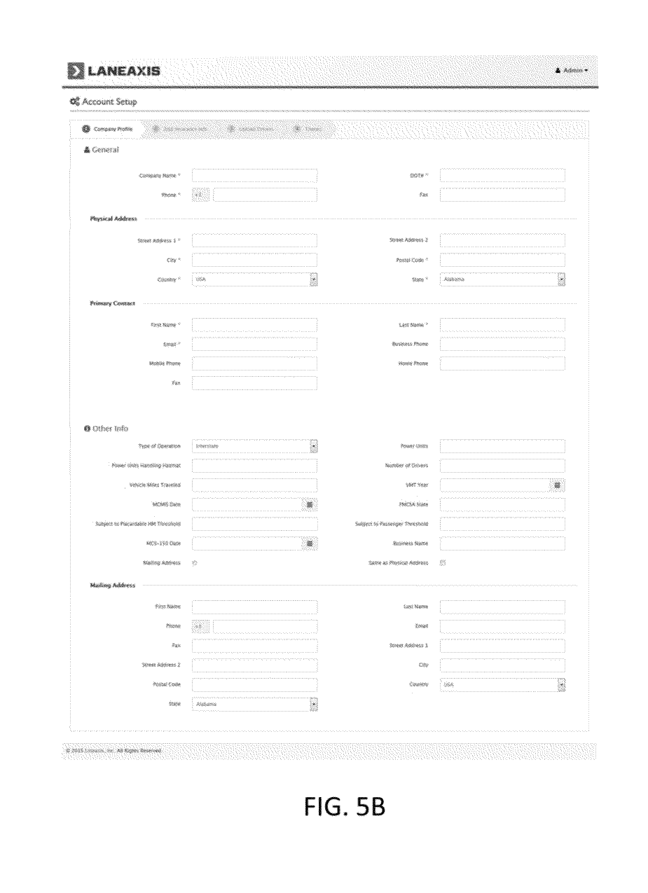

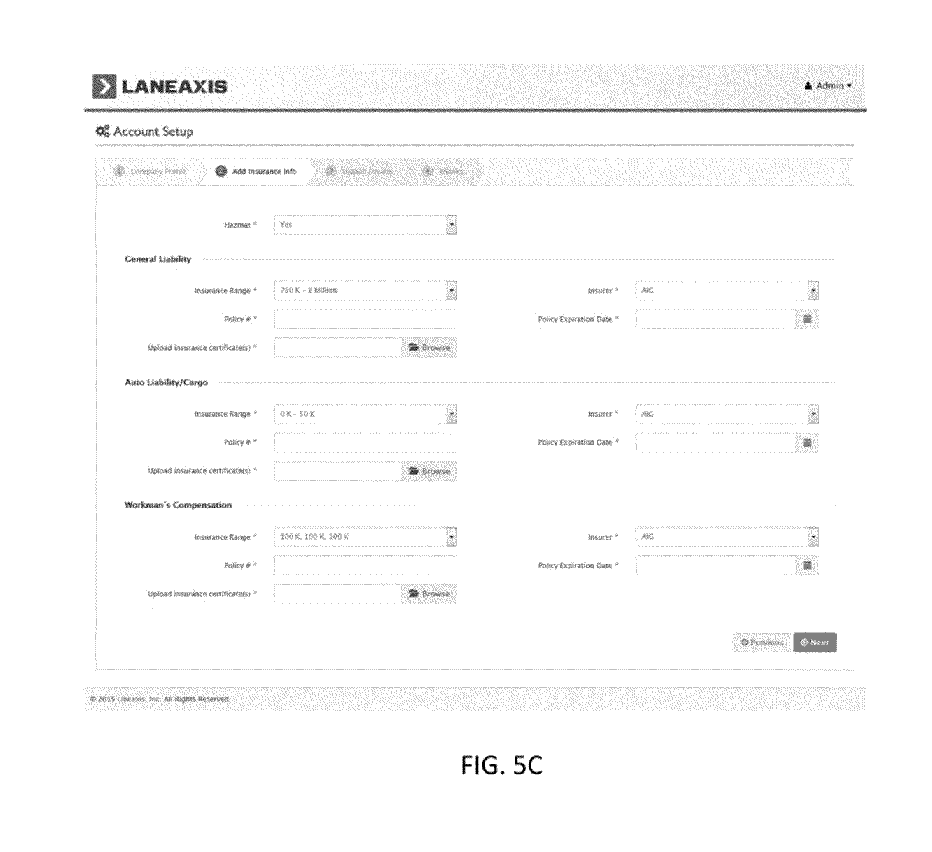

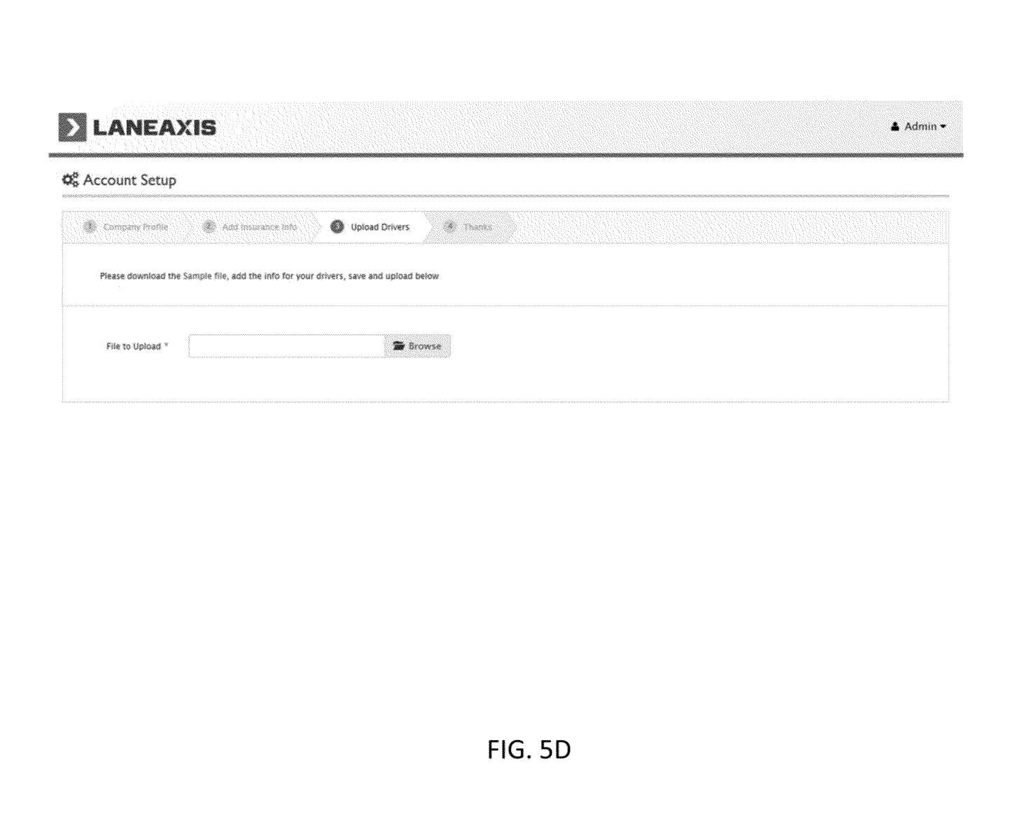

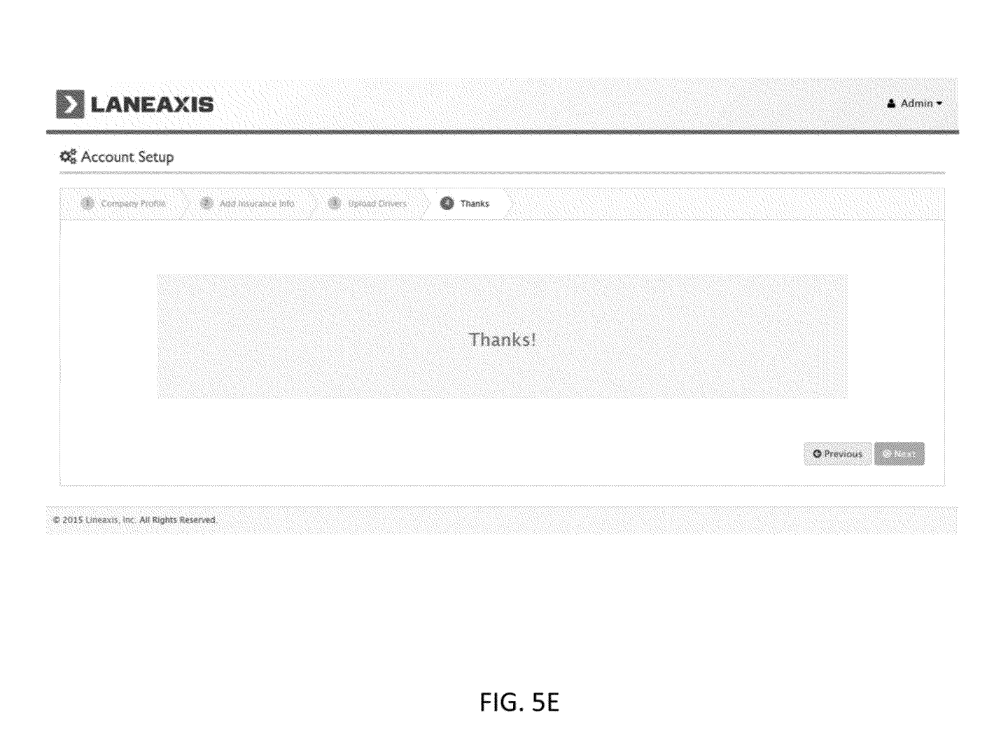

FIGS. 5A-5E are exemplary views of a carrier interface that can be seen when creating a carrier profile for the interaction optimization platform. A carrier can join the associated shipping community by providing log-in information (FIG. 5A) and registration information that can include a department of transportation (DOT) number, business name and address (FIG. 5B).

In some implementations, the data entry fields in the carrier interface can auto-populate based on, for example, the DOT number, business name, address, and the like. The auto-population feature can include detecting an entry in an appropriate data entry field, reading the entry, comparing the entry to values stored in a database, recalling values from the database that are associated with the entry, and populating the data fields in the carrier interface that correspond to the recalled values. Similarly, driver information, such as that described above, can be accessed by the interaction optimization platform through a list which is uploaded by the carrier.

The registration/login features for both the carrier and the shipper can be implemented from a central web site hosted at a server. The central web site can have options for the shipper profile and the carrier profile to be created as described herein, via their respective interfaces. Data used to auto-populate the carrier interface and/or the shipper interface can be automatically retrieved from servers running the interaction optimization platform or external servers such as those at insurance companies, the DOT, and the like. As described above, the retrieval can be in response to detected and analyzed entries into the data entry fields.

The shipper and carrier interaction optimization platform can also accept insurance information (FIG. 5C) and equipment information from the carrier (FIG. 5B). The equipment information can include the equipment type, the maximum weight accepted by the equipment, and the carrier's equipment ID. The equipment type can include van, flatbed, refrigerated, and the like. The carrier can also provide driver information to the shipper and carrier interaction optimization platform by the carrier (FIG. 5D). The driver information can include each driver's name, each driver's mobile phone number, and the identification number or name assigned to each driver by the carrier. Additional information can be associated with each driver, such as the equipment he or she is authorized to operate, preferred routes, and the like. Once a carrier becomes a member of the associated shipping community, the carrier can post the availability of his or her equipment, as well as bid to be the carrier on shipments posted by shippers within the community.

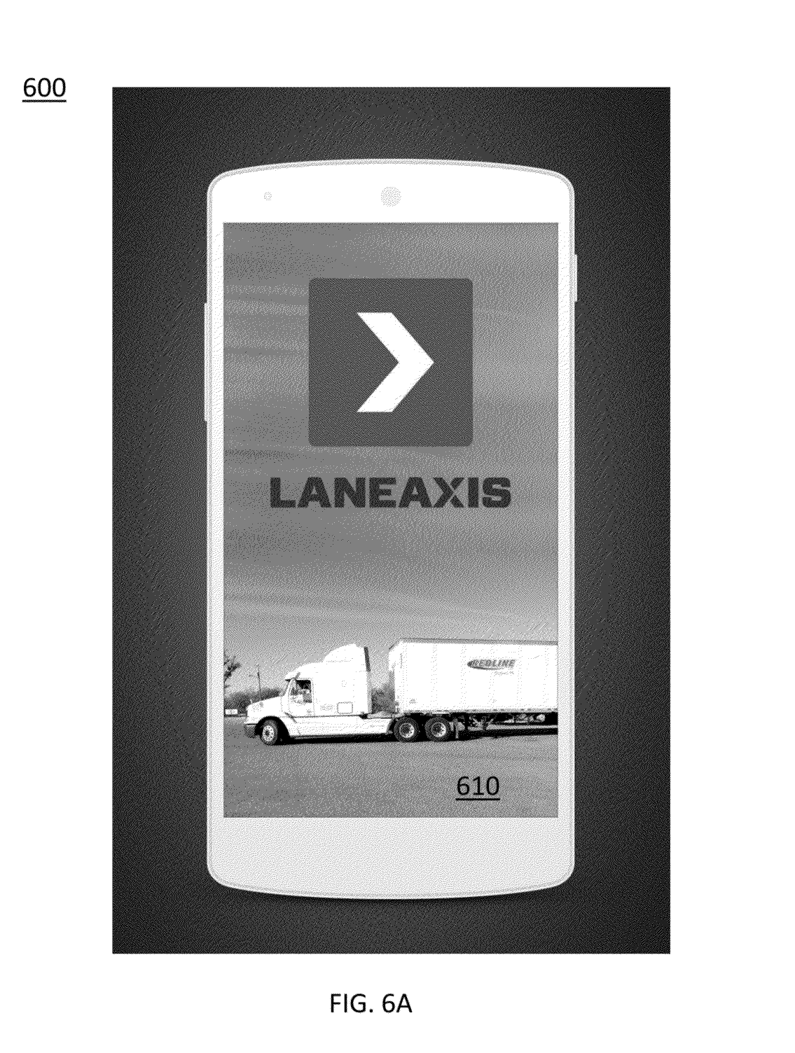

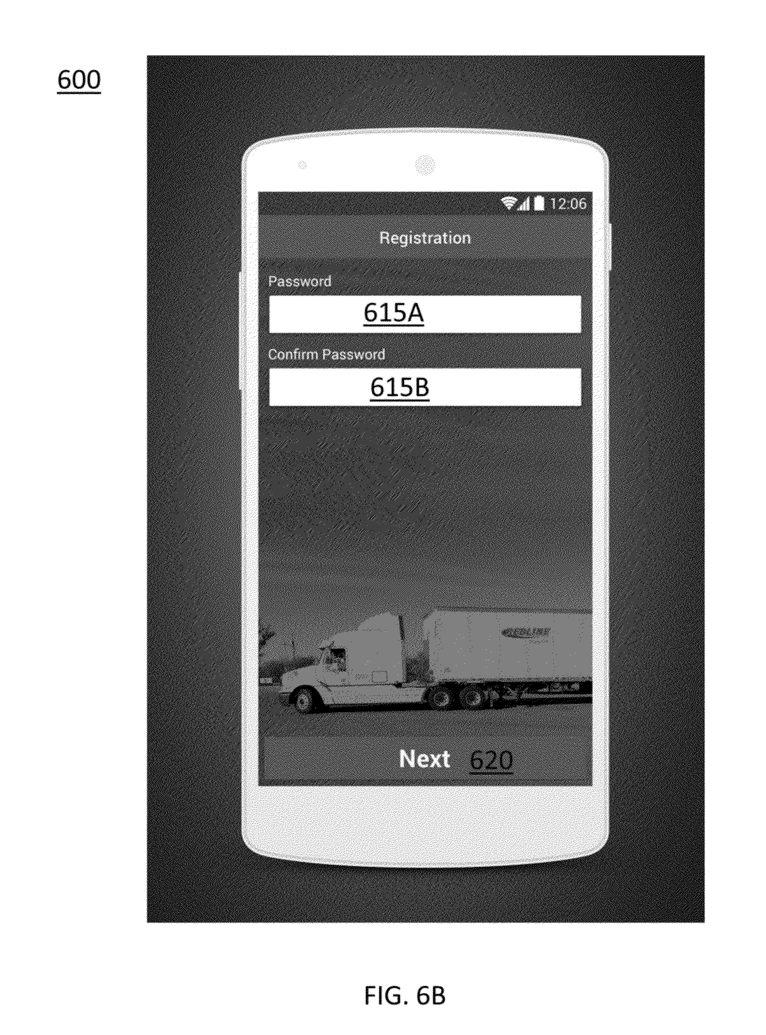

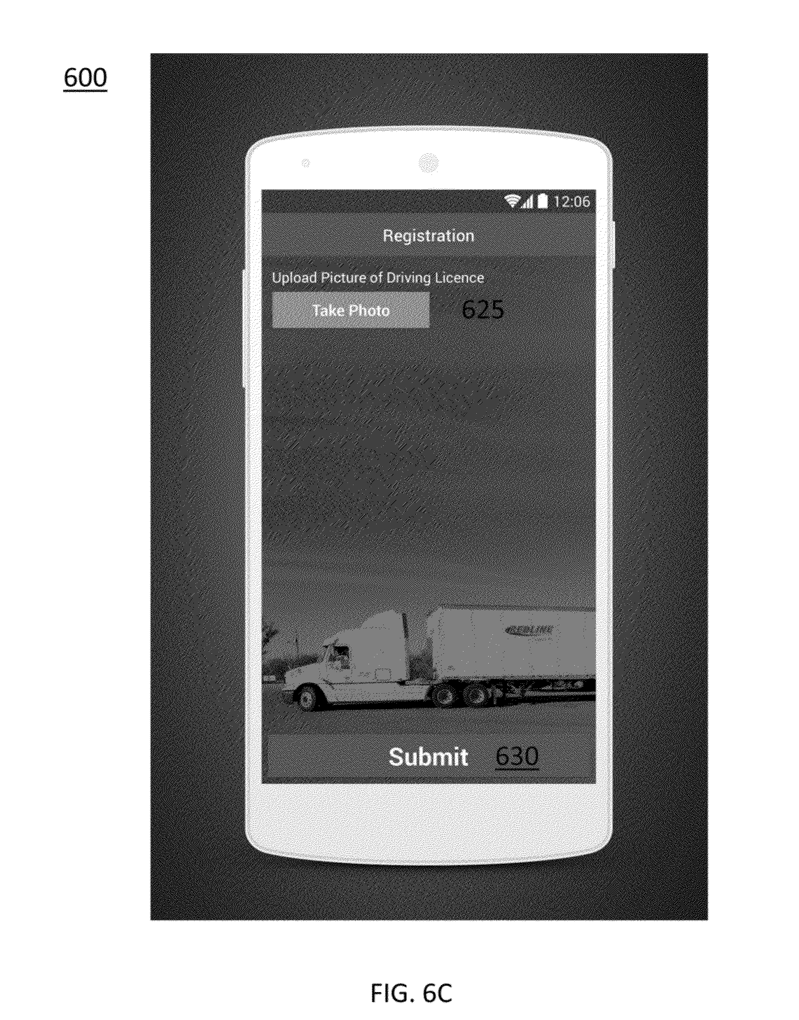

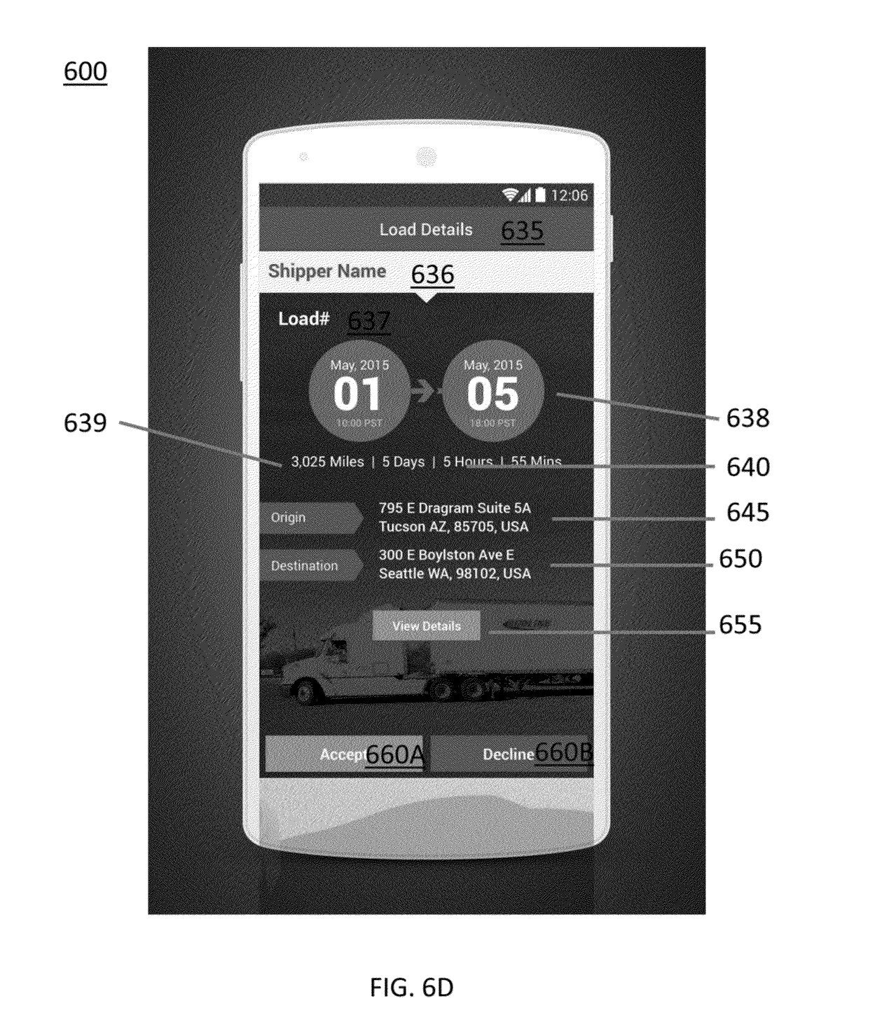

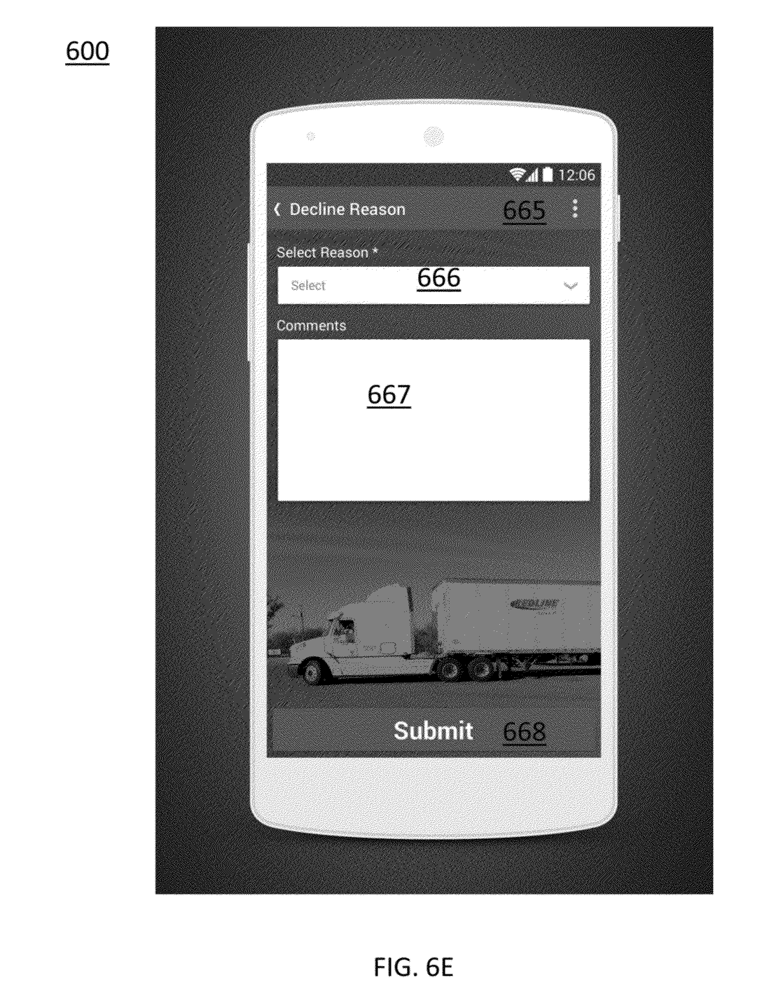

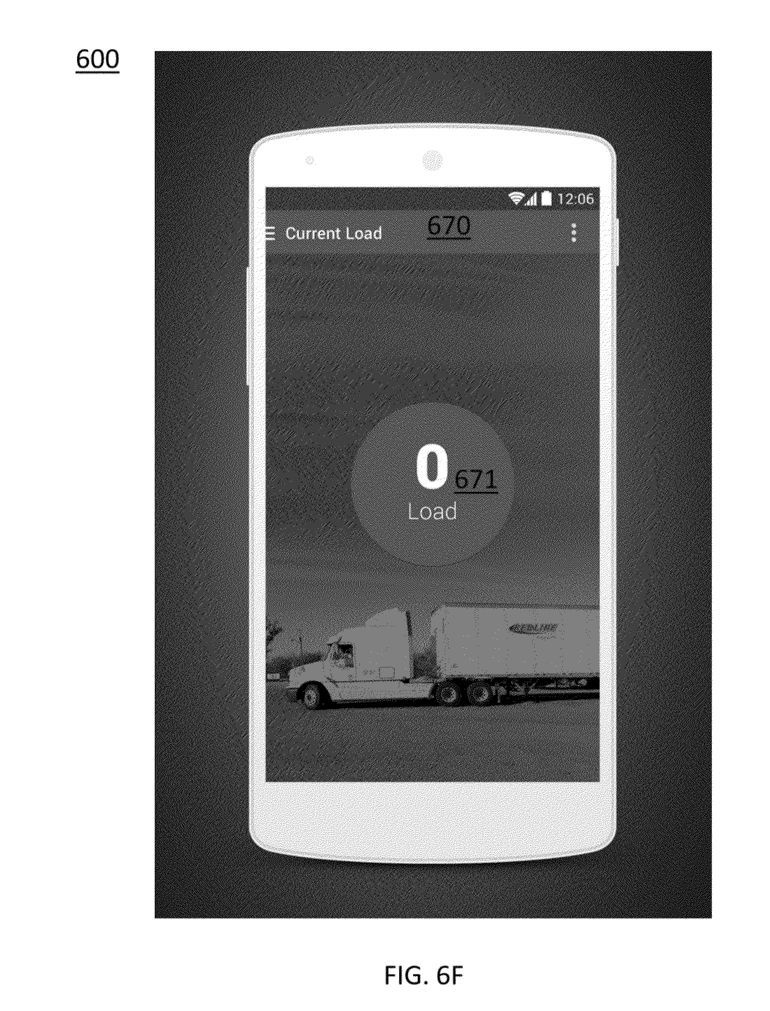

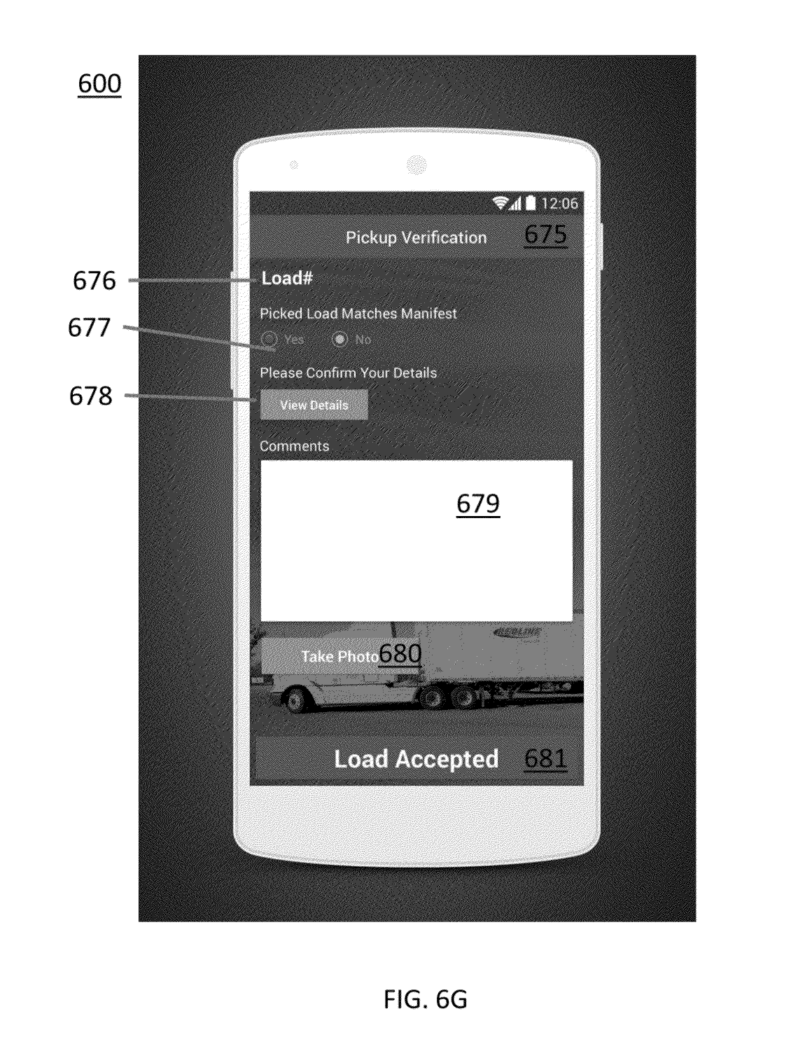

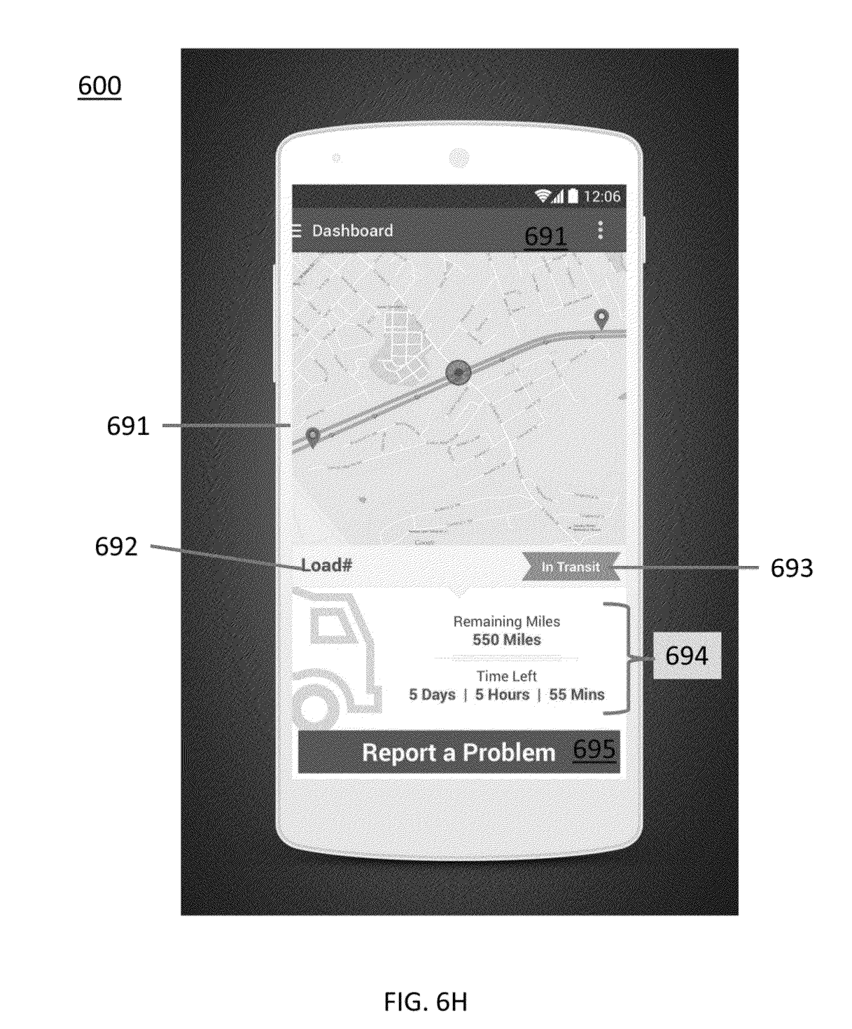

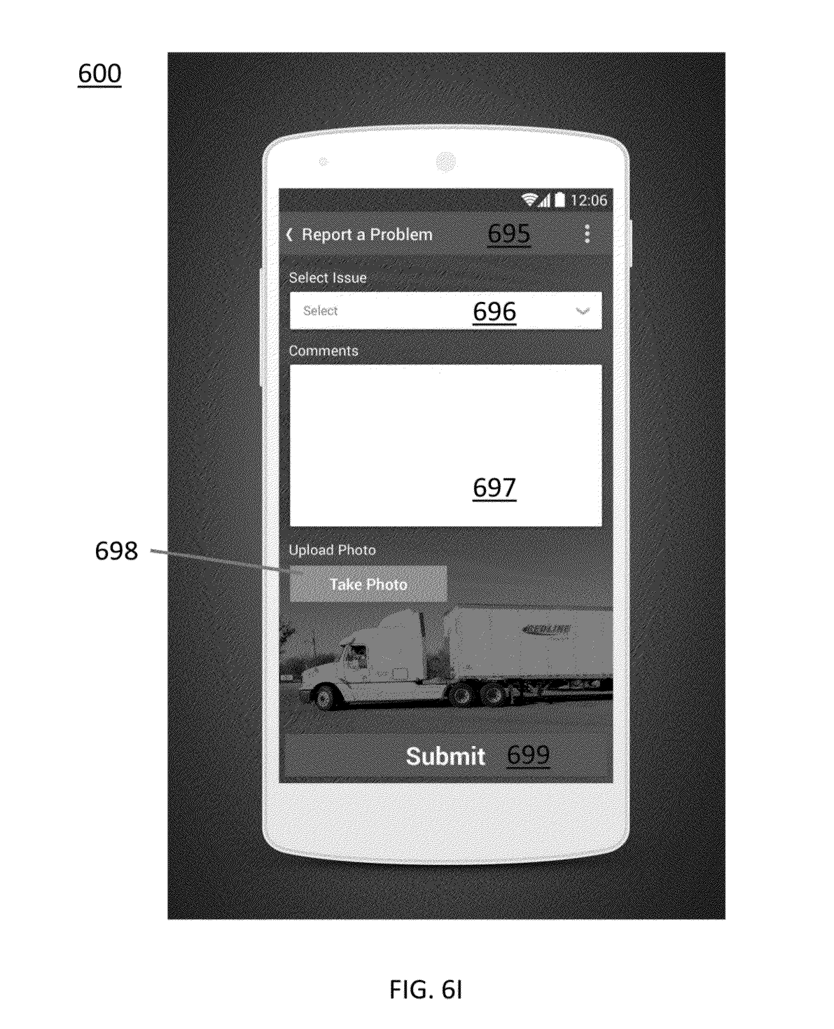

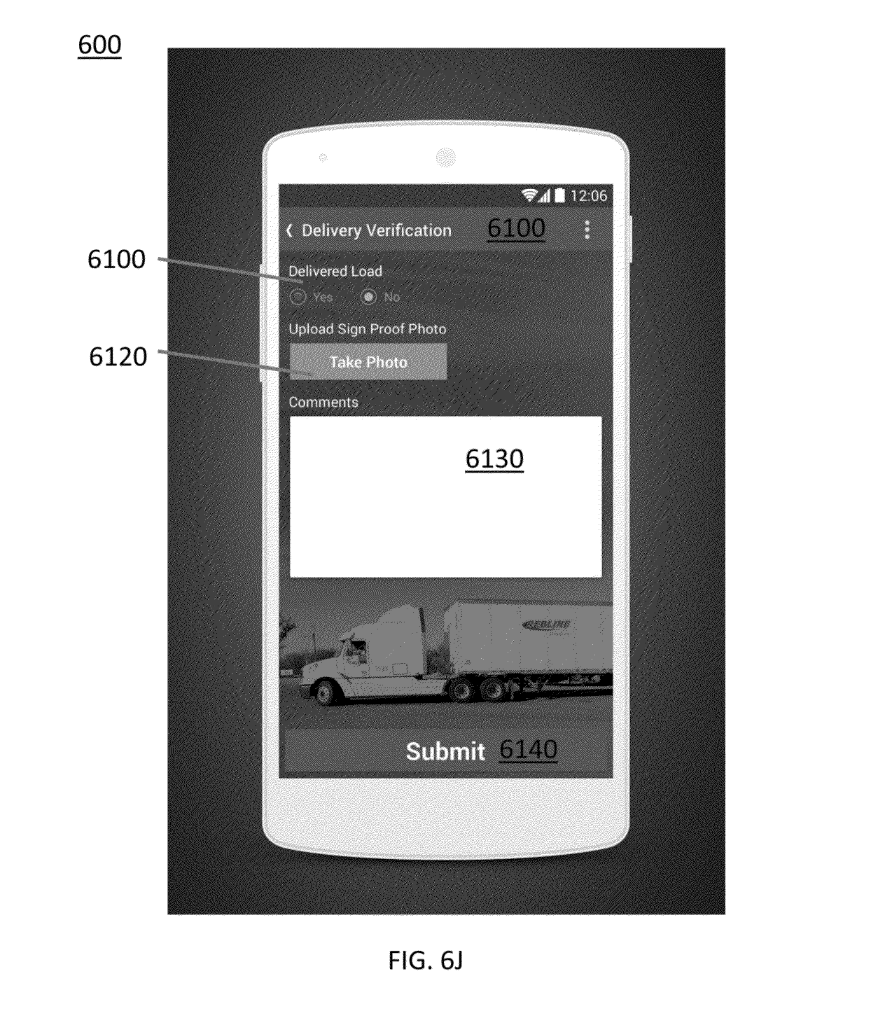

FIGS. 6A-6J are exemplary views of the carrier interface 600 as displayed on a mobile computing device, such as a driver's mobile phone or tablet device. FIG. 6A shows an exemplary landing page or starting view 610 for the carrier interface 600. FIGS. 6B and 6C show registration views of the carrier interface 600. The user (e.g., the driver) is prompted to enter a password in fields 615A and 615B, then select the next button 620. The user can then take a photo of his or her driver's license by selecting the appropriate button 625 and submit 630. The photo may be used to verify the driver's identity and credentials. FIG. 6D shows how a shipment, or load, may be presented in the carrier interface for acceptance. If the carrier accepts the shipment, then the carrier agrees to abide by the shippers business rules and contract and to deliver the shipment.

The interaction optimization platform can monitor the status of the carrier's compliance with the contract. The monitoring can include, for example, providing a notification to the shipper and/or carrier if the contract expires, is within a predetermined period of time from expiring, or if the contract becomes invalid due to a violation of one of the terms specified in the contract, and the like. As used herein, the contract can be, for example, an electronic document, text file, spreadsheet, and the like. The contract (also referred to herein as the “document”) can be generated by either the shipper or the carrier and be uploaded to the interaction optimization platform for electronic distribution to all concerned parties.

The load details 635 can include the shipper name 636, load number 637, dates and times of the shipment start and end 638, the number of miles to cover 639, the expected time needed to deliver 640, the origin location 645, the destination location 650, and further details 655. The user, or driver, can opt to view more details 655 and see information such as further shipment requirements, an electronic copy of the shipment manifest, payment details, the main contact person, and the like. The driver or carrier can choose to accept 660A or decline the shipment 660B by selecting the appropriate button on the interface. FIG. 6E shows the view that can be seen when a driver or carrier selects decline 660B. The header indicates that a decline reason 665 is requested, and the driver can select a reason from the drop down menu 666 and/or write an explanation for declining the shipment 667. Once the reason for the decline is prepared, the reason can be submitted by selecting the appropriate button 668.

FIGS. 6F-6J show views that can be seen when a carrier or driver selects to accept 660A a shipment. The current load view 670, designated by a load number 671, is shown in FIG. 6F. This information can be useful when a carrier has queued up many loads along a route or in a finite time period ahead of time. The pickup verification view 675 is shown in FIG. 6G. This view provides the load number 676 and then provides ways for the driver or carrier to indicate details about the load or shipment as he or she took possession of it onto his or her equipment. For example, the driver can indicate whether the load matches the manifest 677, the route and shipment details can be confirmed 678, and comments can be noted 679. The comments can indicate unusual circumstances or occurrences during loading of the shipment. Should something be wrong, or if the driver would like to show the condition of the shipment before and/or after loading onto his or her equipment, the driver can take a photo 680 of the shipment. Once the shipment is successfully examined and/or loaded, the load can be accepted and an indication of this can be sent to the interaction optimization platform by selecting the load accepted button 681 on the carrier interface 600.

FIGS. 6H and 6I show the progress interface, or dashboard, 690 for the carrier interface of the interaction optimization platform. The progress interface can include a map 691; the shipment, or load, number 692; the shipment status 693; time and distance information 694; and the option to report a problem 995. The map 691 can include a view of the origin and destination of a shipment, the route that has been selected, and an indicator of the current location of the load. Checkpoints can be displayed on the map, particularly if the route is long or complicated, and the location of the shipment can be shown relative to the origin, destination, and/or any checkpoint. Once the shipment is a threshold distance or time away from a checkpoint or other significant location, and automatic alert can be sent to the shipper and/or carrier.

FIG. 6I shows an exemplary view of a problem or exception reporting interface. If a driver wishes to report a problem 695, the driver can indicate a type of issue 696 and provide comments or details 697. A photo can be associated with the problem by selecting the take photo button 698. Once all of the details have been provided by the driver, the information can be submitted to the platform by selecting the submit button 699. The problem can be automatically forwarded to the shipper and/or carrier (e.g., the carrier's driver supervisor or road side assistance dispatcher).

Once the shipment is delivered, the progress interface can automatically switch to the delivery verification view 6100. Alternatively, or additionally, the driver can select the delivery verification view once shipment delivery is eminent. In this view, seen in FIG. 6J, delivery of the load can be indicated with the push of a button 6110, and proof of signature by the accepting party at the destination can by recorded digitally 6120. Comments can be recorded, as well, 6130, such as information regarding the final condition of the shipment and the like. Once this information has been input into the carrier interface, it can be submitted by selecting the submit button 6140. Delivery notification can be automatically delivered to the shipper and/or carrier once the submit button 6140 is selected.

In some implementations, the interaction optimization platform can store a delivery status associated with each shipment. The delivery status can indicate that a shipment is delivered, not delivered, in transit, and the like. Once a shipment is verified as delivered, the delivery status, stored as a variable on a server hosting the interaction optimization platform can be updated. The delivery status variables can be associated with their respective shipments to identify shipments that have been delivered. The dashboard, or other graphical outputs displayed on the carrier interface and/or the shipper interface, can be updated to indicate that the shipment has been delivered.

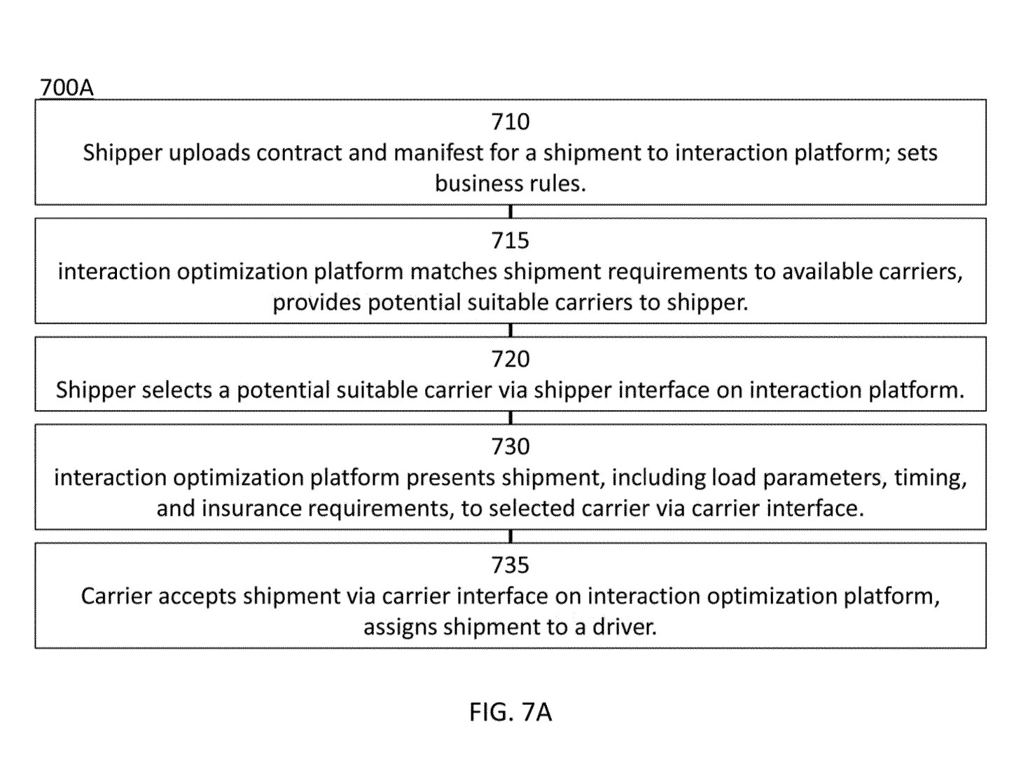

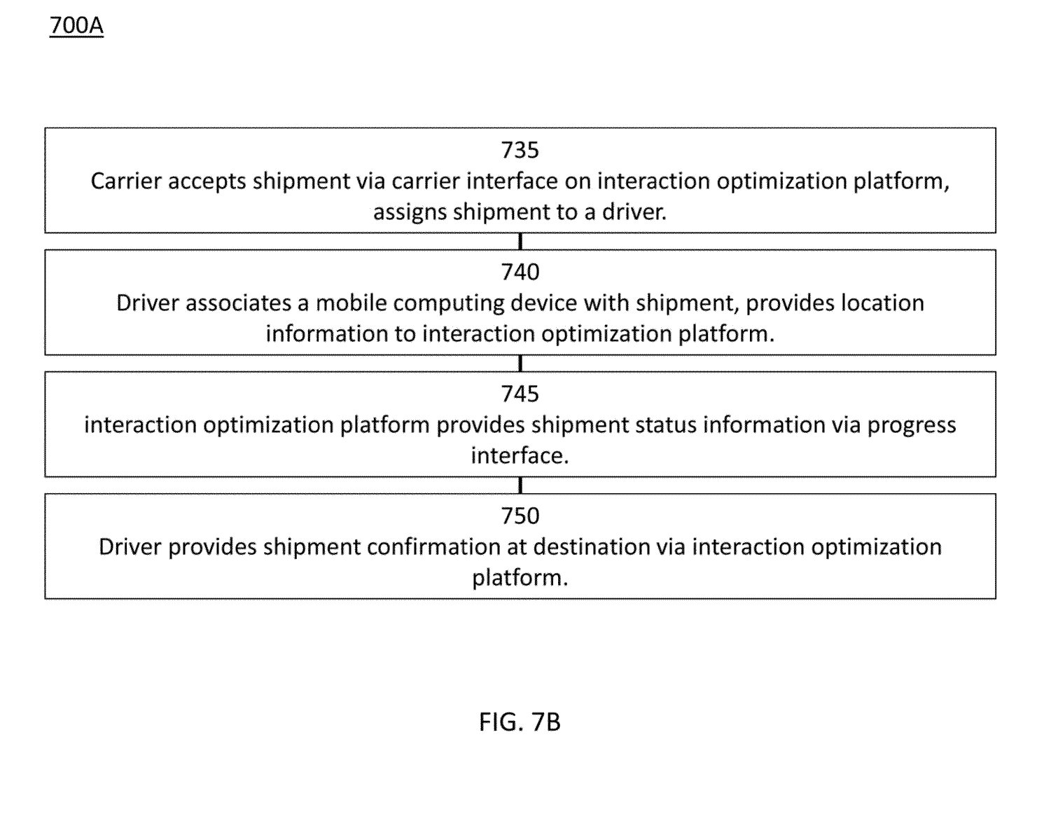

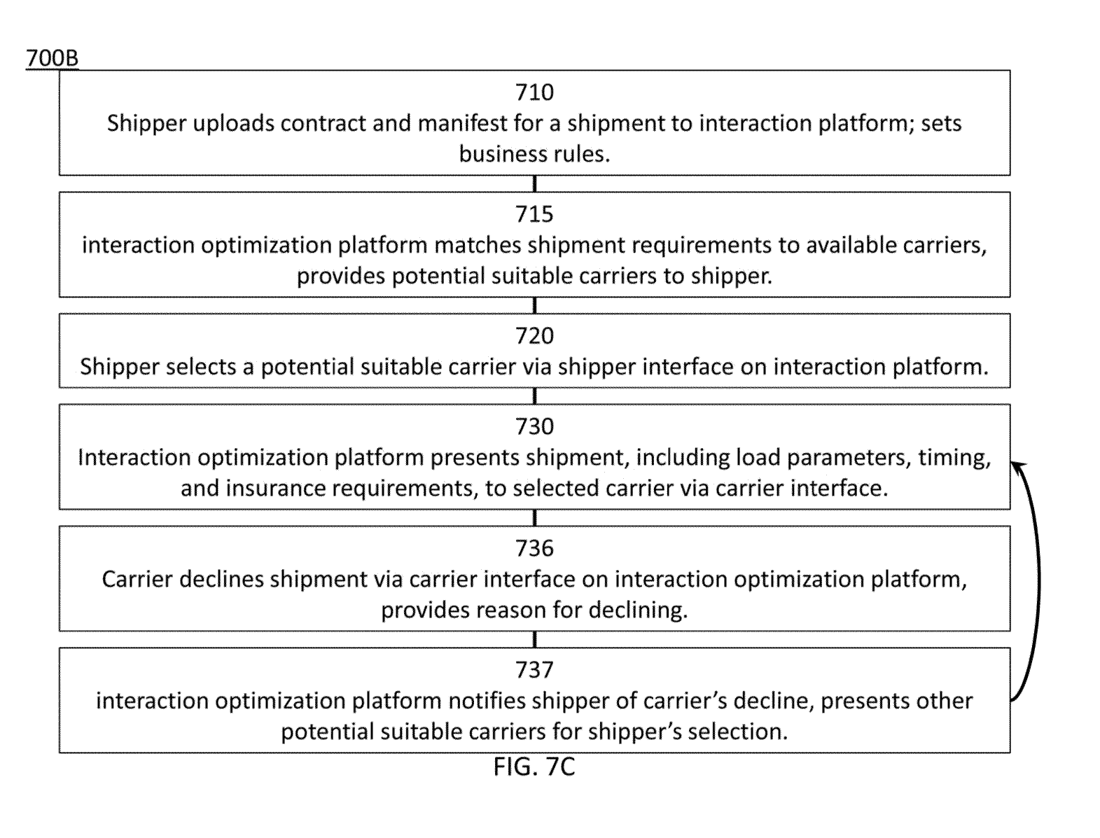

FIGS. 7A-7C show exemplary methods of interaction between a shipper and a carrier via an interaction optimizing platform. The method 700A, or scenario, shown in FIGS. 7A and 7B is for when a carrier accepts a shipment from a shipper. In this scenario, the interaction can start with the shipper uploading a contract, a manifest, and/or business rules, 710. The interaction optimization platform can match the shipment requirements indicated by the shipper to available carriers, 715. The result of this matching can be provided to the shipper via the shipper interface. The shipper can select a potential suitable carrier using the shipper interface, 720.

The interaction optimizing platform can then transmit shipment information for one or more shipments to one or more potential suitable carriers. The transmission can be initiated by the selection of the potential suitable carriers using the shipper interface. In another implementation, the transmission can be initiated by a separate user input at the shipper interface. For example, several potential suitable carriers can be selected and the shipment information can be transmitted to all of them substantially simultaneously. In yet another implementation, the shipment information can be transmitted automatically by the interaction optimizing platform to any shippers that meet the shipment requirements. The selected (or qualifying) carrier can then receive information about the shipment 730 and can accept the shipment 735. The carrier can assign the shipment to a particular driver 735. The driver associates his or her mobile computing device (e.g., smart phone, tablet computer) with the shipment 740 and the mobile computing device provides location information and/or other status information to the interaction optimization platform 745. The interaction optimization platform can provide that information in a useful manner via a progress interface 745. Also, the interaction optimization platform can support the sending of electronic communication between the driver/carrier and the shipper, for example, text messages, video, audio, and the like. The electronic communication can be stored by the interaction optimization platform to provide a log of events that occurred between pick-up and delivery of the shipment. Once the shipment reaches its destination, confirmation can be sent through the interaction optimization platform 750.

FIG. 7C shows a representative scenario 700B in which the carrier or driver has declined a shipment 736. A reason is sent for declining the shipment 736. This can enable the shipper to tailor his or her search for a carrier in the future. When the interaction optimization platform notifies the shipper of the carrier's decline of the shipment, other potential carriers can be presented to the shipper 737.

In some implementations, declined shipments can be returned to an original shipper. The information on the original shipper, for example, name, address, and the like, can be recalled from the server by the interaction optimization platform. The declined shipment can be returned via a carrier that is going to the original shipper, a combination of carriers that would take the declined shipment to the original shipper, or by a third party.

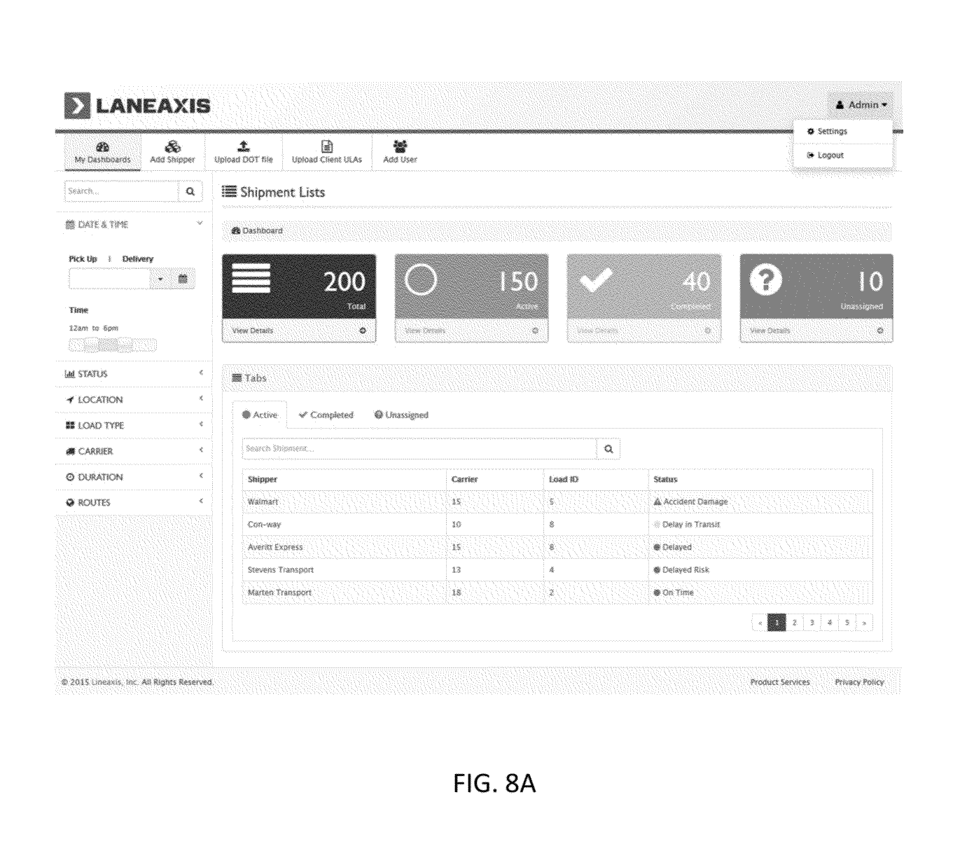

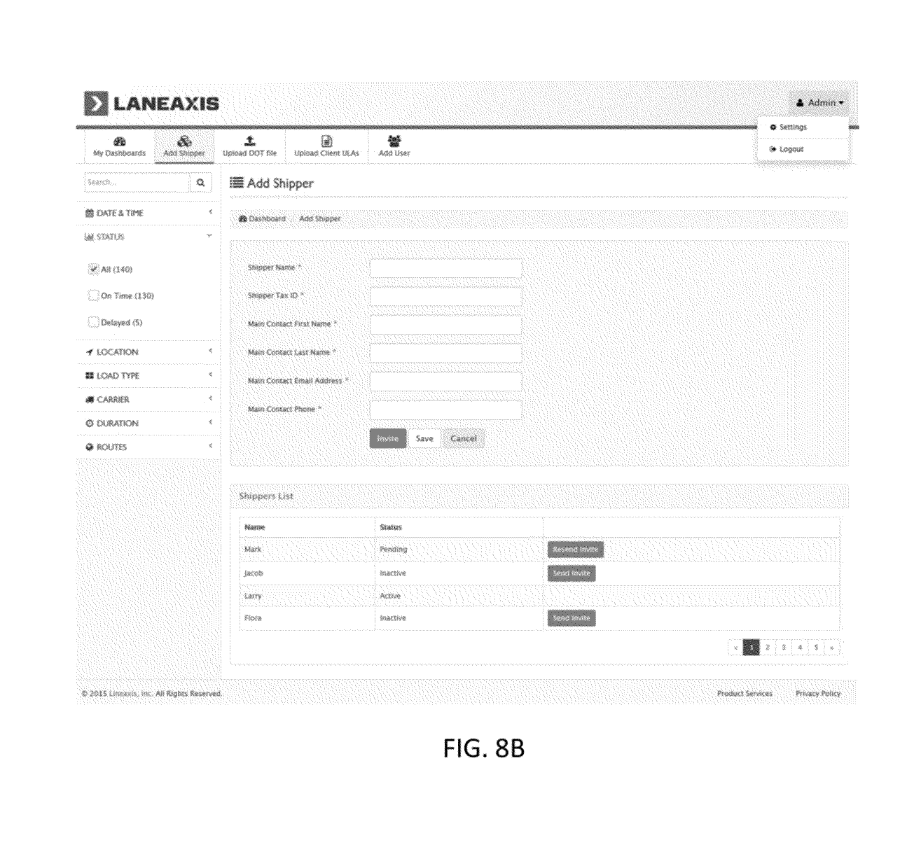

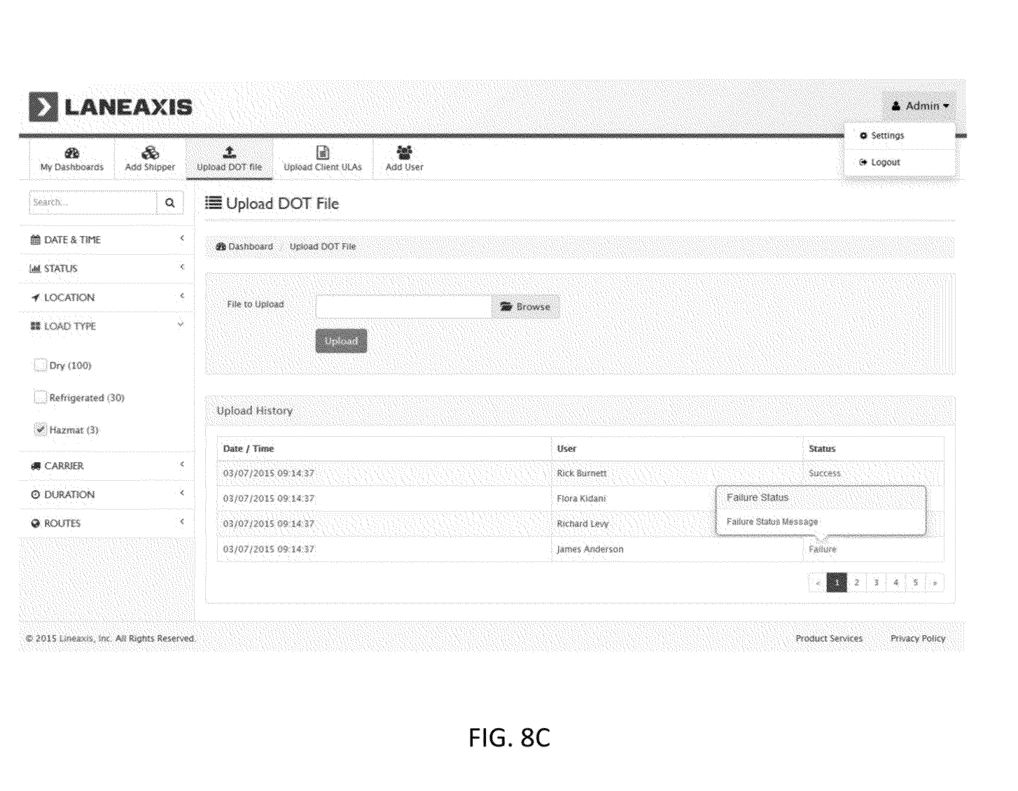

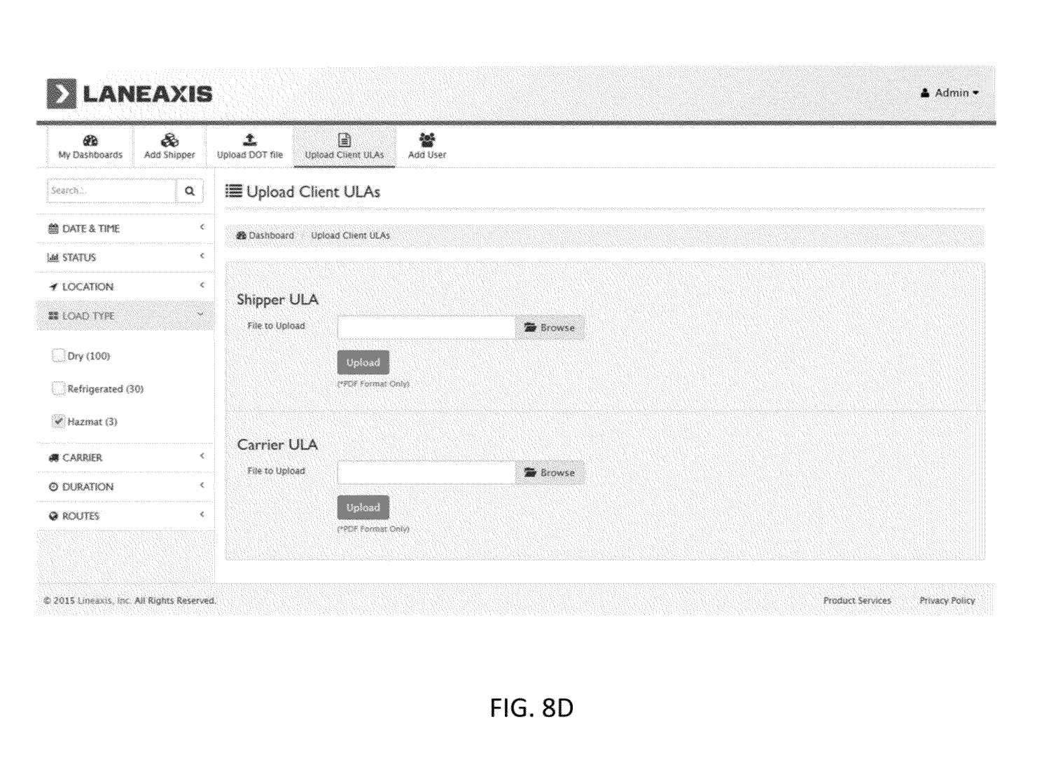

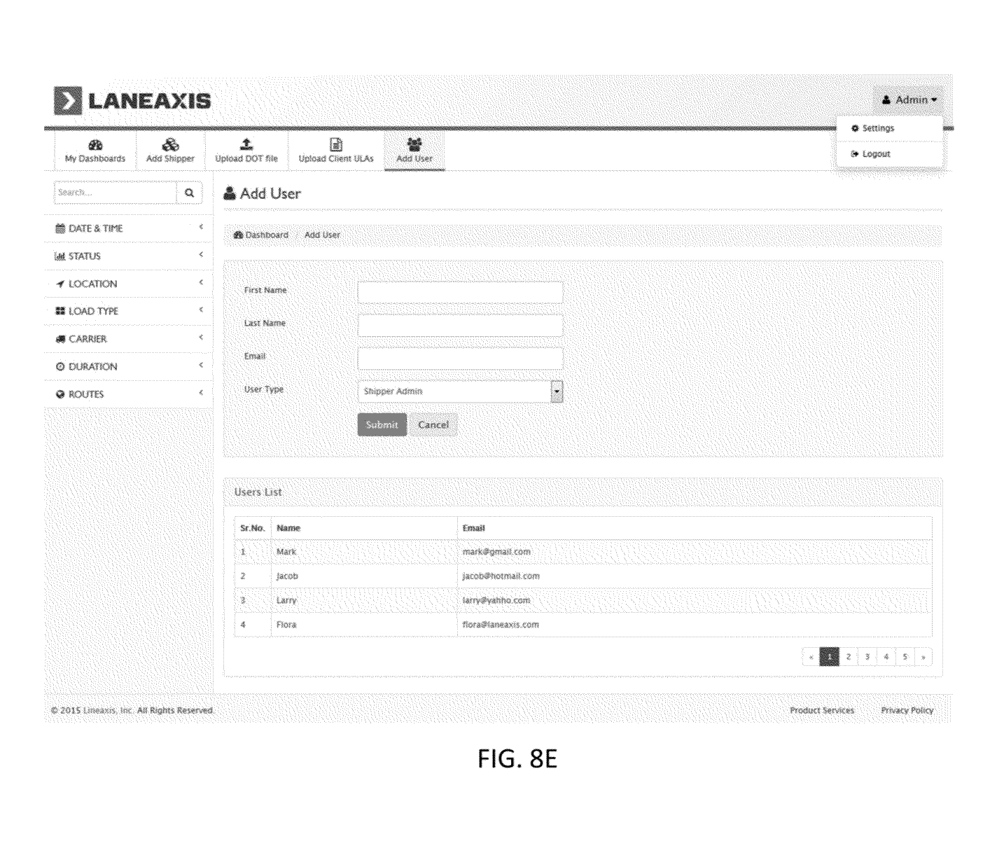

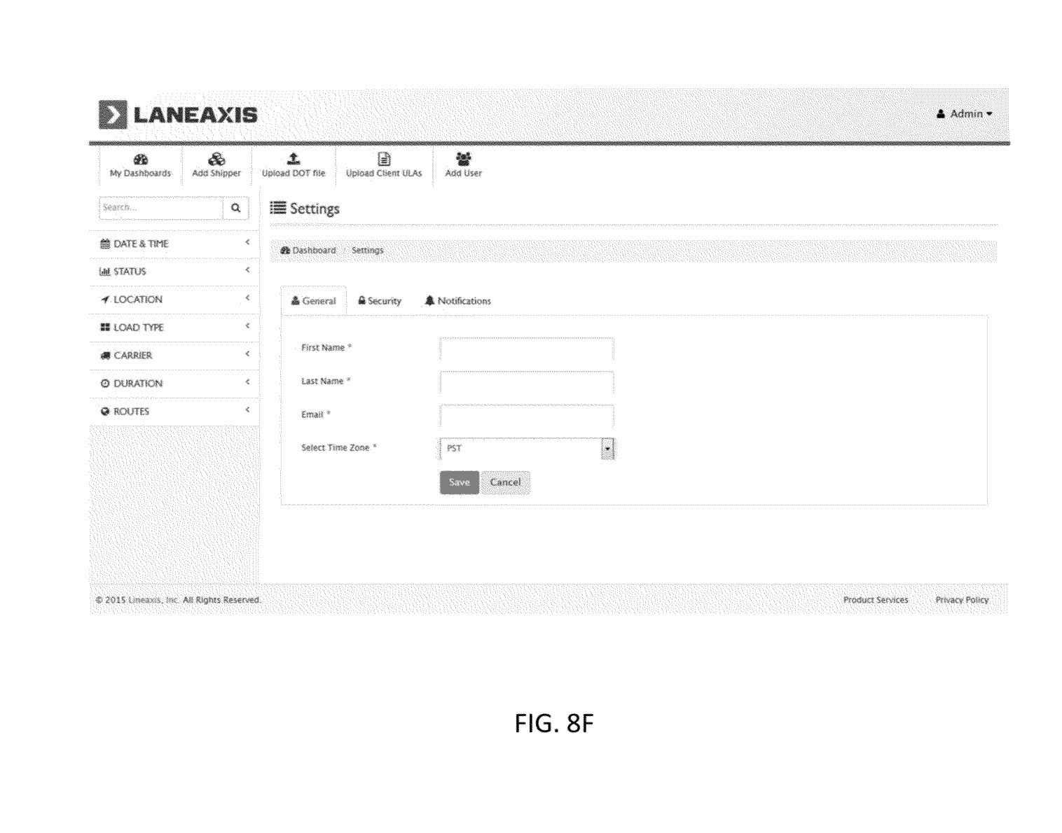

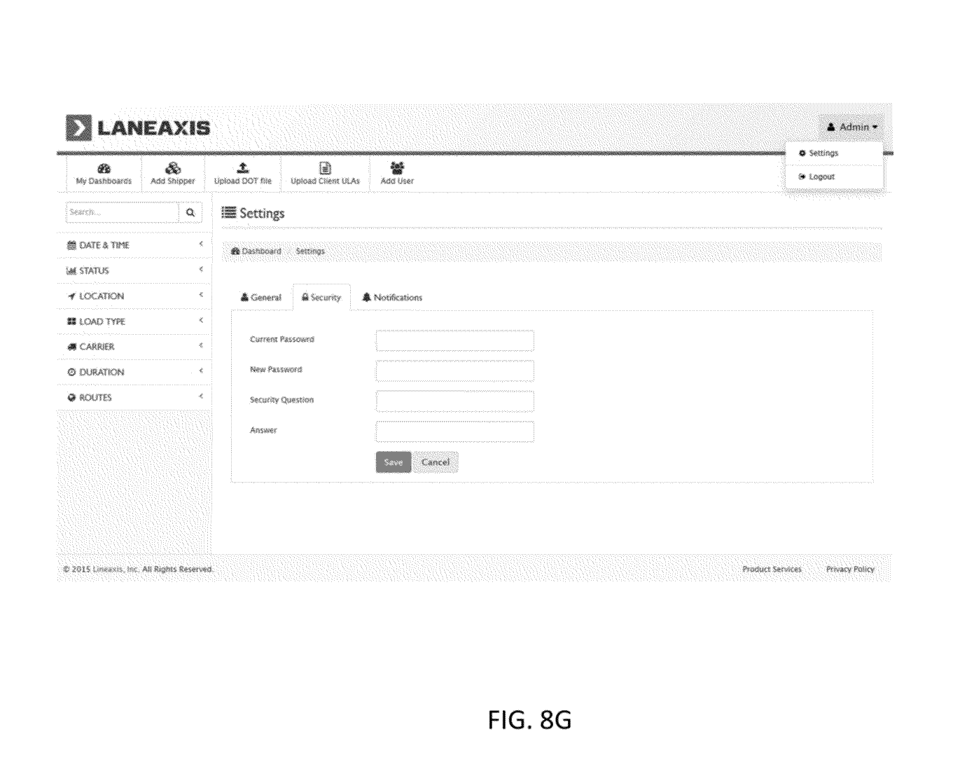

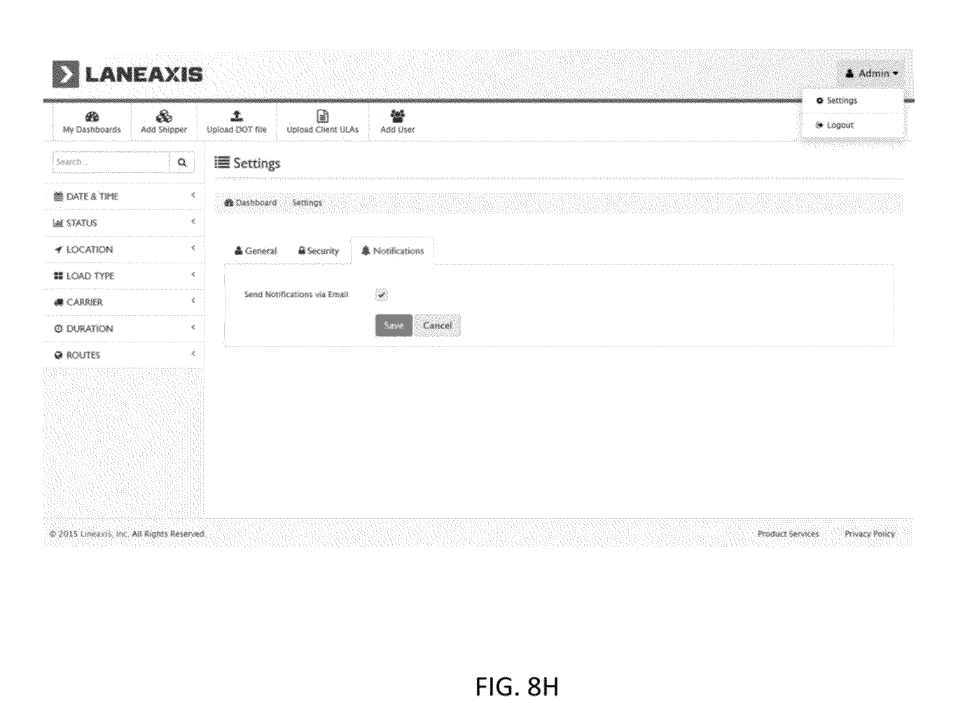

As mentioned above, the input from one or more shippers can include specifications for a shipment, a bid for use of a carrier's equipment, or both shipment specifications and a bid for use of a carrier's equipment. Specifications for a shipment can include a threshold or auto execute cost value, dates for the shipment, point of origin, destination, desired ratings score of the carrier, type of cargo, cargo handling needs, or any combination thereof. A bid for use of a carrier's equipment can include a proposed payment amount. As an alternative to the scenarios in FIGS. 7A-7C, shippers and/or carriers can search postings and tailor bids to those postings to become a highly favorable suitable carrier or shipper. FIGS. 8A-8H show views of the interaction optimizing platform that can be seen by a user, either a shipper or carrier, when creating a bid.

Shippers can send invitations to carriers through the interaction optimization platform. The invitations can be electronic messages, such as texts, emails, and the like. The invitation can include a user-input option for the carrier to accept the shipper's invitation to join the network of available carriers. Examples of user-input options can be clickable hyperlinks, buttons such as on a touch screen, confirmation emails or texts, and the like. The interaction optimization platform can provide the shipper the option of automatically engaging a carrier when the carrier meets the shipper's criteria for a particular shipment, including the cost for fulfilling the shipment. Upon automatically engaging a carrier that meets the acceptable criteria, both the shipper and carrier can be notified via e-mail, text message, phone message, or any combination thereof. Additionally, each shipment posted by a shipper has time lines, including deadlines, of when the shipment needs to depart a point of origin, as well as when it needs to arrive. After being posted to the platform, a shipment posting can be identified, such as by color coding or categorizing, by the time until the shipment needs to depart its point of origin, such as in FIG. 8A. For example, if a posted shipment is within twenty-four hours of its departure time, the posting can be color coded yellow. Once the shipment is within a shorter time period, such as 4 or 2 hours from its departure time, the shipment posting can be color coded red. Expired shipment postings can be categorized as either expired-fulfilled or expired-unfulfilled and displayed only when a shipper or carrier searches for such shipment postings.

The input from one or more carriers can include equipment availability information, a bid for the cost of transporting a shipment of cargo, or both equipment availability information and a bid for the cost of transporting a shipment of cargo. The equipment availability information can include the type of equipment available, the dates and time of availability, the threshold cost of hiring, an auto execute hiring value, availability origin location, availability destination location, and any combination thereof. A bid for the cost of transporting a shipment of cargo can include the hourly driver cost, the mileage cost for the equipment, fuel costs, special route costs (e.g., tolls, bridge assessments, taxes, or the like), special handling costs upon loading or delivery, and any combination thereof.

As with the shipment postings, equipment availability postings can have an auto-execute setting which prompts the platform to accept a bid on behalf of the carrier once certain criteria are met. One of the criteria can be the price that the shipper is willing to pay to engage the carrier and his or her equipment.

It is feasible that a carrier can post his or her equipment as available while bidding to be the carrier for shipments with deadlines that coincide with the posted availability of the equipment. In such cases, should a bid to provide service be accepted by a shipper, the availability post can be removed by the carrier. Conversely, should the carrier accept a bid to hire equipment, the carrier should remove any conflicting bids to supply equipment to a shipper. Alternatively, the platform can remove conflicting posts on behalf of the carrier either concurrently with or after notification of the post's removal. A carrier or shipper can also control the types of notifications he or she receives (FIG. 8H), as well as updating contact information and other relevant information (FIGS. 8B-8G).

The platform can provide interfaces for tracking any shipment, for generating proof of delivery, for creating lists of preferred shippers or carriers, for generating cost estimates, for locating shipments with origins that coincide with the termination of one shipment, or any combination thereof. The shipper and carrier interaction optimization platform can suggest matches for each posting, such that a shipper can see which carriers have posted or indicated availability that matches a shipment's specifications or such that a carrier can find out which shipments meet the availability of his or her equipment. Such proposed matches can facilitate agility in the shipper's schedule, such as when the shipper is suddenly inconvenienced due to weather or other traffic obstructions, or when there is an unexpected surge in orders that require fulfillment. Another benefit of such proposed matches can be that carriers can minimize the number of trips made by drivers with empty vehicles, that is to say without cargo or a shipment.

Tracking each shipment using the shipper and carrier interaction optimization platform can entail using positioning components and/or software on each driver's hand held device (e.g., mobile phone, smartphone, tablet or the like), on built-in positioning equipment on a carrier's vehicle, or on a positioning component on a dedicated computing device used by a driver during shipment delivery. Positioning components and/or software can use global positioning satellite systems (GPS systems), cell tower or other cell signal information, Wi-Fi signal information, or the like to indicate position and progress of a shipment.

The shipper and carrier interaction optimization platform can provide special alerts associated with the position of a carrier's driver with respect to a point of origin and a destination. At the beginning of a shipment, after both the shipper and the carrier have agreed to enter into a service relationship, the shipper can receive an alert indicating the distance of the carrier's appointed driver from the point of origin for the shipment he or she is contracted to transport. A threshold distance, or geo-fence, can be pre-determined by the shipper or by the shipper and carrier interaction optimization platform. This pre-determined, threshold distance can be selected to give the shipper an idea of the timeliness of the carrier's driver, but also to allow for preparation for the arrival of the driver. Additionally, or alternatively, the shipper and carrier interaction optimization platform can alert the shipper, the carrier, or both the shipper and carrier when a driver is within a pre-determined threshold distance from the shipment destination, breaching the geo-fence. The alert can be an e-mail, a voice message, a text message, an audio alert, a haptic alert, or any combination thereof.

The shipper and carrier interaction optimization platform can accept a shipping manifest when a post is accepted for a shipping opportunity or when a shipper's bid for hiring equipment is accepted by a carrier. Once the bid is accepted, the associated shipping manifest can be electronically delivered to the carrier automatically by the shipper and carrier interaction optimization platform. When the carrier assigns a shipment to a particular driver or drivers, the corresponding shipping manifest can be automatically sent to the driver's or drivers' position indicating computing device (e.g., hand held telephone or computing device, GPS, or wearable computing device). Multiple shipments that are assigned to the same driver can be consolidated into a single shipment. The consolidated shipment can be displayed on the carrier and/or shipper interface to show the different shipments that were consolidated. Alternatively, the consolidated shipment can be displayed as a normal shipment, for example, by not retaining information about which shipments were consolidated. In all the respects described herein, the consolidated shipment can be treated as any other shipment, for example, tracked, transferred, monitored, having a consolidated manifest, and the like.

One or more geo-fences can be delineated within the shipper and carrier interaction optimization platform and the position of the shipment relative to the one or more geo-fences can be calculated with respect to the driver's or drivers' position indicating computing device. Further, or alternatively, in such implementations, a mobile application or a web site can launch once the position indicating computing device breaches the corresponding geo-fence after the shipment is loaded onto the carrier's equipment. The one or more geo-fences can include a geo-fence about the point of origin, about the destination, and about points along a predetermined route from the point of origin to the destination. Using such geo-fences, the shipper and carrier interaction optimization platform can indicate to the shipper, the carrier, the driver, or any combination thereof, when the shipment has deviated and is “off route,” such as by sending alerts, messages, and the like.

At any time after accepting the shipment, the shipment location can be updated in the interaction optimization platform by uploading to the interaction optimization platform, current GPS data for the mobile device associated with the shipment. The updating can occur at regular intervals, for example, every minute, 5 minutes, 15 minutes, 30 minutes, 1 hour, and the like. These intervals can be set by the interaction optimization platform by recalling the interval time from the server, or can be specified by user-input received at the shipper interface. In some implementations, the updating can occur when the driver is between the geo-fences of the origin location and the destination location. The shipment information can be stored at these, or other, periodic intervals to provide an archival record of the transport of the shipment. The shipment information can be stored at a server and include, for example, the route taken, times of pick-up, arrival, and waypoint passage, electronic documents such as manifests, transportation “paperwork,” changes made to the transit process during shipping, pictures of an accident/damage from an accident, communications to/from the driver, and the like.

When the driver and shipment breeches a geo-fence about the shipment's destination, then an eminent delivery alert can be sent by the shipper and carrier interaction optimization platform to the shipper, the carrier, the driver, or any combination thereof, indicating “real-time delivery.” A geo-fence is useful as some destination sites are not at a specific address, but can be a large destination location that spans a great distance.

At this time, the shipper and carrier interaction optimization platform can prepare a proof of delivery interface that the driver can present to an authorized person at the destination or that the driver can fill out to prove delivery. Further, or alternatively, the actual delivery time (e.g., the time the shipment reaches the destination precisely or the time the shipment is off-loaded from the equipment) can be sent with the proof of delivery to the shipper and carrier interaction optimization platform. The updating of the shipment location can be stopped once the driver and shipment breaches the destination geo-fence. Alternatively, it can stop when the driver reaches the exact specific destination if a specific destination location is desired.

As mentioned above, the shipper and carrier interaction optimization platform can provide both the shipper and the carrier with useful information. Once a bid has been accepted and a shipper and a carrier have come to an agreement with respect to a shipment, the shipper and carrier interaction optimization platform can e-mail the shipment manifest directly to the hand-held device of the carrier's driver or drivers. The shipper and carrier interaction optimization platform can provide alerts to both the shipper and carrier regarding location of the driver, location of the shipment, shipment exceptions (e.g., last minute changes in quantity or destination), and potential impediments to the shipment delivery, such as weather delays, traffic jams, and the like. In some implementations, GPS data and/or manually entered traffic conditions can be transmitted by the carrier interface or other associated mobile device to the interaction optimizing platform. This traffic data can provide updated traffic conditions that can be incorporated into shipping time estimates, computation of travel routes, providing alerts of possible delays, and the like. The location of the shipment, by tracking the location of the driver's hand held device, wearable computing device, or GPS device, can be monitored in real time, with the location data updated during transit at regular intervals, for example each minute, 5 minutes, 15 minutes, 30 minutes, 1 hour, and the like. In some implementations, the update intervals can be specified by the shipper by entering a value into the shipper interface. Highly valued or expedited loads can be set to update more often, for example every five minutes, compared to lower priority loads that can be set to update, for example, every 30 minutes. The shipper and carrier interaction optimization platform can detect the timeliness of the shipment, and if the shipment is projected to be delayed by more than a predetermined, threshold amount of time, then an alert can be sent to the shipper, the driver, the carrier, or any combination thereof. Upon completion of the shipment, or at any time, the carrier can be rated by the shipper. The rating can be, for example, on a 1-5 scale or a 1-10 scale to provide an indication of the carrier's timeliness, courteousness, safety, and the like. The rating can be entered via user-input received at the shipper interface, the carrier interface. Optionally, the rating can be automatically generated based on data acquired during the shipping. Once entered or generated, the rating can be stored as electronic data in a computer memory of the interaction optimizing platform.

To prevent the use of the carrier interface while the carrier is on the road, the carrier interface can be disabled from accepting input while the vehicle associated with the driver/carrier interface is moving. In some implementations, the location and/or speed of the computing device running the carrier interface can be monitored by the server and/or the mobile device associated with the carrier interface. When a predefined speed is exceeded, user input to the carrier interface can be disabled or limited. Upon detection, by the carrier interface or the interaction optimizing platform, that the computing device running the carrier interface has a speed at or below the predefined speed, user input can be re-enabled. In other implementations, the enabling/disabling can be based on a user-generated input or received instruction, for example from the server, that the shipment is moving and that the computing device executing the carrier interface is “on the road.” The determination of whether the shipment is moving can be based on, for example, GPS data at the server describing the shipment location. Similarly, there can be user-generated input or received instructions that indicate that the carrier interface is not “on the road.” In some implementations, these features can operate independently of any location tracking programs such as GPS, for example, by the carrier interface receiving a user-input specifying that the shipment is in transit.

By tracking the times in which a driver's mobile device is being used for a shipment, the interaction optimization platform can calculate and store the hours-of-service (HOS) for the driver. The HOS calculation can take into account movement of the shipment, for example by not counting times in which the driver is not moving, or if the driver indicates with the carrier interface that they are off-duty. The HOS tracking data can be stored locally to the driver's mobile device, or uploaded to the interaction optimization platform. The shipper interface or carrier interface can display a graphical representation, for example, a table, chart, graph, or the like, of the driver's HOS. The graphical representation can cover any span of time, for example, a 24 hour period, a week, two weeks, or a complete record since the first available HOS data. In some implementations, the HOS data can be deleted after a specified period of time, for example, weekly, every two weeks, every month, etc. The deletion time can be specified by, for example, the interaction optimization platform system administrator, or automatically set by accessing of current reporting rules imposed by government agencies. Similarly, other driver data analytics can be reported to shippers, employers, or governmental agencies. Driver data analytics can include, for example, what routes were travelled, driving behavior such as speeds or time of day of travel, information about what shipment was being transported, and the like. The reporting of driver data analytics can be in response to a received request at the shipper and/or carrier platform, or performed automatically or at predefined intervals by the interaction optimization platform.

The shipper and carrier interaction optimization platform can be a free to join system. Shippers and carriers that are part of the associated shipping community can view available equipment or shipping jobs free of charge, in some cases with the information regarding the posting party redacted. In some implementations, members of the associated shipping community can pay for each bid that is accepted in response to a post. Alternatively, or additionally, members of the associated shipping community can pay a fee for each month in which a bid is accepted in response to a post. For example, cost for each accepted bid can be a first amount, and the monthly cost can be a second amount that is about two times or more than the first amount (e.g., the first amount is $19.95 and the second amount is $39.95). In some implementations, costs can be borne by the party whose bid was accepted. In other implementations, only the carriers can pay fees to use the shipper and carrier interaction optimization platform. In other implementations, costs can be borne by both the shipper and carrier. However, in some such implementations, either the carrier or the shipper can pay more for using the shipper and carrier interaction optimization platform.

The carrier interface can provide offer data such as locations, lists, alerts, and the like, of services or locations that provide rebates, which may be of interest to the carrier. This offer data can be provided as graphical output to the carrier interface, text alerts, emails, and the like. Based on the position of the carrier, nearby locations of interest can be displayed at the carrier interface. The determination of what offer data to display can be made at a central server of the interaction optimizing platform or on the carrier's mobile device. The determination can be based on the shipment location being within a predefined distance from a location of interest corresponding to the offer data. In some implementations, locations of interest (corresponding to offer data) along a predetermined route can be displayed on carrier interface. Once the determination is made, the offer data can be transmitted to the mobile device associated with the carrier interface. Updates to the offer data can be made in real-time or at predefined intervals, for example, by the minute, hour, day, and the like. Examples of offers can include truck leasing programs, cellular service/data rebates, fuel discounts, loading funds onto dedicated credit cards, tire rebates, roadside assistance, tax return filing rebates, IFTA tax reporting assistance/rebates, options for quickpay, repair locations/vendors and associated rebates, and the like.

The carrier and/or shipper interface can support the posting of routes, messages, shipment information, planned stops, and the like, to social media web sites, webpages, blogs, and the like.

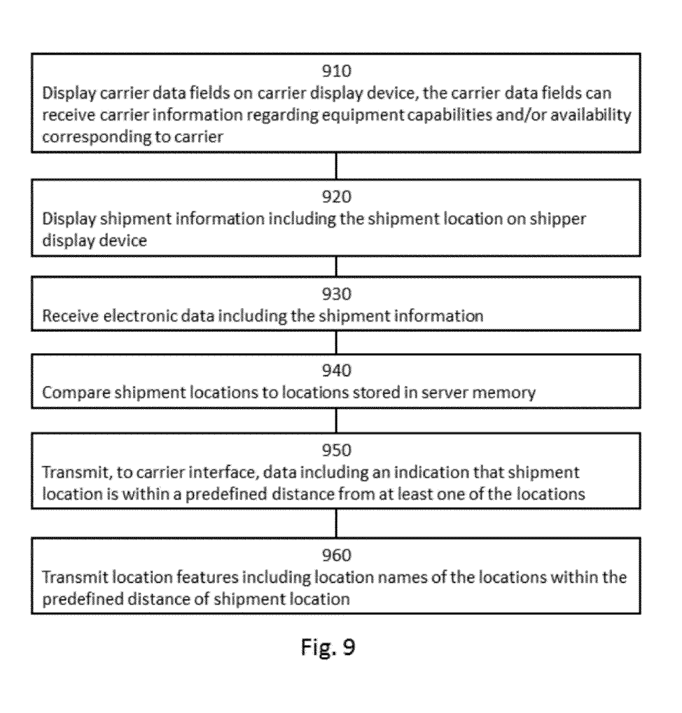

FIG. 9 shows a flow chart showing an exemplary method of providing data regarding locations of interest based on their proximity to the shipment location.

At 910, carrier data fields can be displayed on a carrier display device. The carrier data fields can receive carrier information regarding equipment capabilities and/or availability corresponding to a carrier.

At 920, the shipper display device can display shipment information including the shipment location.

At 930, a server can receive electronic data including the shipment information.

At 940, the server can compare the shipment location to locations stored in a server memory.

At 950, the server can transmit, to the carrier interface, data including an indication that the shipment location is within a predefined distance from at least one of the locations.

At 960, the server can also transmit location features including location names of the locations within the predefined distance of the shipment location.

Aspects of the subject matter described herein can be embodied in systems, apparatus, methods, and/or articles depending on the desired configuration. Some implementations of the subject matter described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications, applications, components, or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Because of the high-level nature and complexity of the selections and methods described herein, including the multiple and varied combinations of different tasks, including the detection of the location of carrier's driver, and real-time coordination of the available shipments with available equipment, the calculations, computations and selections cannot be done in real time quickly or at all by a human. The processes described herein rely on the machines described herein.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A system for optimizing selection of a carrier for a shipment having a shipment location, the system comprising:
an interaction optimization platform comprising:
a carrier interface configured to display, on a carrier display device, one or more carrier data fields for receiving carrier information regarding equipment capabilities and/or availability corresponding to a carrier; and
a progress interface configured to display, on the shipper display device, shipment information comprising the shipment location; and
a server configured to, by execution of the interaction optimization platform, perform operations comprising:
receive electronic data comprising the shipment information;
compare the shipment location to a plurality of locations stored in a server memory; and
transmit, to the carrier interface, data comprising:
an indication that the shipment location is within a predefined distance from at least one of the plurality of locations; and
location features comprising a location name of the at least of the one plurality of locations within the predefined distance of the shipment location.

2. The system of claim 1, wherein the carrier information further comprises safety capabilities and wherein the server is further configured to perform operations comprising:
receive, from a second server, electronic data comprising safety requirements for transporting the shipment;
determine, based on the safety requirements and the safety capabilities, which of a plurality of carriers meets the safety requirements; and
display, at the carrier interface, a graphical indication of the plurality of carriers that meet the safety requirements.

3. The system of claim 1, wherein the server is further configured to perform operations comprising:
monitor a status of a carrier, the status indicating compliance with a previously confirmed set of rules or with an electronic document previously received by the carrier and the shipper; and
transmit a notification to the carrier and the shipper based on the monitoring determining that the carrier is not in compliance with the set of rules or with the electronic document.

4. The system of claim 1, wherein the server is further configured to perform operations comprising transmitting, to one or more potential suitable carriers, shipment information when the one or more potential suitable carriers meet shipment requirements defined by the shipper with a shipper interface and received by the server.

5. The system of claim 1, wherein the server is further configured to perform operations comprising transmitting instructions to the carrier interface disabling the carrier interface from receiving at least some user input while a mobile device executing the carrier interface is moving, the determination of the carrier interface as moving based on at least GPS data received at the server.

6. The system of claim 1, wherein the server is further configured to perform operations comprising transmitting, to the carrier interface, instructions to display a graphical output offer data comprising a location of interest when the location of interest is within a predefined distance from the shipment location.

7. The system of claim 1, wherein the server is further configured to perform operations comprising receiving, at intervals defined by a shipper interface, the shipment information.

8. A method for implementation by at least one programmable processor, the method comprising:
displaying, on a carrier display device, one or more carrier data fields for receiving carrier information regarding equipment capabilities and/or availability corresponding to a carrier; and
displaying, on the shipper display device, shipment information comprising the shipment location; and
executing, at a server, an interaction optimization platform to perform operations comprising:
receive electronic data comprising the shipment information;
compare the shipment location to a plurality of locations stored in a server memory; and
transmit, to the carrier interface, data comprising:
an indication that the shipment location is within a predefined distance from at least one of the plurality of locations; and
location features comprising a location name of the at least of the one plurality of locations within the predefined distance of the shipment location.

9. The method of claim 8, wherein the carrier information further comprises safety capabilities and wherein the server is further configured to perform operations comprising:
receive, from a second server, electronic data comprising safety requirements for transporting the shipment;
determine, based on the safety requirements and the safety capabilities, which of a plurality of carriers meets the safety requirements; and
display, at the carrier interface, a graphical indication of the plurality of carriers that meet the safety requirements.

10. The method of claim 8, wherein the server is further configured to perform operations comprising:
monitor a status of a carrier, the status indicating compliance with a previously confirmed set of rules or with an electronic document previously received by the carrier and the shipper; and
transmit a notification to the carrier and the shipper based on the monitoring determining that the carrier is not in compliance with the set of rules or with the electronic document.

11. The method of claim 8, wherein the server is further configured to perform operations comprising transmitting, to one or more potential suitable carriers, shipment information when the one or more potential suitable carriers meet shipment requirements defined by the shipper with a shipper interface and received by the server.

12. The method of claim 8, wherein the server is further configured to perform operations comprising transmitting instructions to the carrier interface disabling the carrier interface from receiving at least some user input while a mobile device executing the carrier interface is moving, the determination of the carrier interface as moving based on at least GPS data received at the server.

13. The method of claim 8, wherein the server is further configured to perform operations comprising transmitting, to the carrier interface, instructions to display a graphical output offer data comprising a location of interest when the location of interest is within a predefined distance from the shipment location.

14. The method of claim 8, wherein the server is further configured to perform operations comprising receiving, at intervals defined by a shipper interface, the shipment information.

15. A computer program product comprising a non-transient, machine-readable medium storing instructions which, when executed by at least one programmable processor, cause the at least one programmable processor to perform operations comprising:
displaying, on a carrier display device, one or more carrier data fields for receiving carrier information regarding equipment capabilities and/or availability corresponding to a carrier; and
displaying, on the shipper display device, shipment information comprising the shipment location; and
executing, at a server, an interaction optimization platform to perform operations comprising:
receive electronic data comprising the shipment information;
compare the shipment location to a plurality of locations stored in a server memory; and
transmit, to the carrier interface, data comprising:
an indication that the shipment location is within a predefined distance from at least one of the plurality of locations; and
location features comprising a location name of the at least of the one plurality of locations within the predefined distance of the shipment location.

16. The computer program product of claim 15, wherein the carrier information further comprises safety capabilities and wherein the server is further configured to perform operations comprising:
receive, from a second server, electronic data comprising safety requirements for transporting the shipment;
determine, based on the safety requirements and the safety capabilities, which of a plurality of carriers meets the safety requirements; and
display, at the carrier interface, a graphical indication of the plurality of carriers that meet the safety requirements.

17. The computer program product of claim 15, wherein the server is further configured to perform operations comprising:
monitor a status of a carrier, the status indicating compliance with a previously confirmed set of rules or with an electronic document previously received by the carrier and the shipper; and
transmit a notification to the carrier and the shipper based on the monitoring determining that the carrier is not in compliance with the set of rules or with the electronic document.

18. The computer program product of claim 15, wherein the server is further configured to perform operations comprising transmitting, to one or more potential suitable carriers, shipment information when the one or more potential suitable carriers meet shipment requirements defined by the shipper with a shipper interface and received by the server.

19. The computer program product of claim 15, wherein the server is further configured to perform operations comprising transmitting instructions to the carrier interface disabling the carrier interface from receiving at least some user input while a mobile device executing the carrier interface is moving, the determination of the carrier interface as moving based on at least GPS data received at the server.

20. The computer program product of claim 15, wherein the server is further configured to perform operations comprising transmitting, to the carrier interface, instructions to display a graphical output offer data comprising a location of interest when the location of interest is within a predefined distance from the shipment location.
